(19) United States
(12) Patent Application Publication
(10) Pub. No.: US 2003/0149581 A1
(43) Pub. Date: Aug. 7, 2003

(54) Method and system for providing intelligent network content delivery

(76) Inventors: Imran Chaudhri, Potomac, MD (US); Ken Lee, Oakton, VA (US); Kent Lockhart, Sterling, VA (US); Shan Jiang, Herndon, VA (US); Vishal Suri, Sterling, VA (US)

Correspondence Address: Quine Intellectual Property Law Group, P O Box 458, Alameda, CA, 94501, US

(21) Appl. No.: 10/220,370

(22) PCT Filed: Feb. 28, 2001
(86) PCT No.: PCT/US01/06647

(51) Int. Cl. G06F 17/60

(52) U.S. Cl. 705/1; 705/26

(57) ABSTRACT

Methods and systems for providing improved acceleration of web content and/or related services are disclosed. In specific embodiments, the invention provides services and business arrangements that allow delivery of web content more quickly and effectively using a variety of innovative techniques including: managing content provided to different content distribution networks; providing an easier interface for publishers to sign up for acceleration services and implement acceleration policies; and providing easier billings to publishers and selection of acceleration services.

This application claims benefit of priority from and is a continuation-in-part of patent application Ser. No. 09/728,428 filed Dec. 1, 2000, incorporated herein by reference.

This application claims benefit of priority from provisional patent application No. 60/186,054 filed Feb. 29, 2000, incorporated herein by reference.

### FIELD OF THE INVENTION

The present invention relates to the field of information and/or data provision over a network. More specifically, in specific embodiments, the present invention is directed to methods and/or systems for providing acceleration services over a communications channel or network. In further embodiments, the invention includes methods and/or systems for providing associated services, such as billing, reporting, and/or policy management.

### BACKGROUND OF THE INVENTION

Familiarity with services provided by content distribution networks (CDNs) and network proxy caching, and techniques used therein, is characteristic of practitioners in the art and is presumed to understand particular aspects of the present discussion.

Content Distribution Networks have improved upon the traditional straight-from-the-Web-site content delivery method by taking advantage of the frequency of requests to a Web site. CDNs cache frequently requested static HTML pages and embedded objects in distributed locations that are closer to the end-user making the request. This reduces delivery time and improves performance.

At the present time, CDN services are provided by a number of CDN companies, such as Akamai, Digital Island, Adero, and Mirror Image. Typically, each of these companies has a proprietary and private set of proxy content servers or sources (also referred to as cache sources or edge devices or edge caches) that are geographically distributed. As is known in the art, each of these companies provides a subscription-type service to publishers whereby these companies cache, in a distributed fashion, content from data publishers in order to make that content more quickly available to viewers. For the most part, it is a characteristic of the services provided by such companies that each service is autonomous and does not utilize the cache sources of other companies.

For example, if a web publisher such as www.publisher.com, signs up with a service such as Akamai, viewers attempting to access www.publisher.com content may be redirected to cache sources operated by Akamai. These users will not be redirected to cache sources in any other CDNs operated by other services, even if those other CDNs might provide faster access to a particular user. Generally, user access is provided to CDNs through a reassignment of an address provided by a domain name server (DNS). Related technology is provided by reverse proxy caching vendors such as Net Aps, Inktomi, or Cacheflow.

Furthermore, publishers generally are required to perform a number of steps to initiate CDN services. Publishers may have to run utilities to convert the URLs on all web pages the publishers desire to accelerate. Publishers also may need to establish acceleration policies according to specific formats specified by specific CDN services. In such cases, it is difficult for a publisher to use services from more than one CDN. Various methods are used to provide CDN services. Some providers, such as Akamai, generally require a publisher to translate HTML pages at the publishers web site to include URLs indicating the CDN source for embedded content. Other CDN services, such as Digital Island or Adero, may cache some publisher HTML pages and use DNS redirection to reach the cache sources.

Furthermore, publishers wishing to make arrangements with multiple CDNs will have difficulty in tracking billing and changes from multiple CDNs.

### SUMMARY

The present invention may be understood in the context of content publishers (or content providers) and content access over a communication media. An important application for the present invention, and an independent embodiment, is in the field of providing services over the Internet using Internet multimedia protocols and formats, such as HTTP, RTTP, XML, HTML, VRML, as well as image, audio, or video formats etc. However, using the teachings provided herein, it will be understood by those of skill in the art, that the methods and apparatus of the present invention could be advantageously used in other related situations where users access content over a communication channel, such as cable television systems, wireless systems, etc.

The present invention is involved with a number of unique methods and/or systems that can be used together or independently to provide improved acceleration and/or content distribution of computer formatted content and/or related services. In one aspect, the present invention addresses problems associated with how to deliver content more quickly and effectively, given that there are different CDN (Content Distribution Network) providers with different cache systems, different methods for translating or redirecting addresses (such as URLs) to indicate cached content, different requirements for establishing acceleration policies, different payment and billing policies and calculations, different reporting formats, etc. For a particular network access, a best-existing CDN may not be part of a particular system to which a publisher subscribes.

To address this problem, the present invention adds a management/intermediate function or module or system between various competing CDN systems and publishers. This function facilitates use of a CDN or other communication network for viewer access, directs a viewer to that source, facilitates centralized billing for publishers/customers from multiple CDN sources, facilitates centralized aggregate reporting for publishers/customers from multiple CDN sources, and in specific embodiments can provide updated content and policies to a source on behalf of the publisher. In specific embodiments, the present invention can be understood as involving a new management function as illustrated in Table 2 and as compared to existing relationships as illustrated in Table 1.

TABLE 1
EXISTING RELATIONSHIPS IN
CONTENT DISTRIBUTION SERVICES

| Web Content | Content | Content |
|---|---|---|
| Creation | Hosting | Distribution |
| Yahoo/Disney | Digex | Uunet |
| NY Times/CNN | Exodus | Cidera |
| | Frontier | Internap |
| | | Akamai |
| | | Digital Island |
| | | Mirror Image |

TABLE 2
CONTENT DISTRIBUTION SERVICES
WITH INTELLIGENT CONTENT
MANAGEMENT

| | | Intelligent | |
|---|---|---|---|
| Web Content | Content | Content | Content |
| Creation | Hosting | Management | Distribution |
| Yahoo/Disney | Digex | ← (system of | Uunet |
| NY Times/CNN | Exodus | Retargetters and | Cidera |
| | Frontier | associated | Internap |
| | | modules. e.g. | Akamai |
| | | FASTTIDE ™) → | Digital Island |
| | | | Mirror Image |

A further advantage that will be understood from the teachings herein is that in specific embodiments, the present invention can make it easier for a publisher to initiate acceleration services using multiple CDNs by handling and centralizing the accounting, billing, and service arrangements for a number of CDNs on behalf of a number of publishers. With current competing CDNs, a publisher may have to investigate different CDN performance and interface requirements, may have to variously modify the publisher's content, and if the publisher wishes to access multiple CDNs, may have to enter into multiple contracts, and separately pay for services from multiple CDN providers. Using a system according to the invention, however, a publisher can, for example, make a minor change to his initial home page and a system according to the present invention can access services of multiple CDNs and handle and centralize accounting and billing.

In a further aspect, the invention can provide reports from the intermediary for publishers that document and/or summarize content acceleration and distribution services from multiple CDNs and/or from the retargetter infrastructure.

Thus, the invention according to specific embodiments can be understood as involving a new business method for providing CDN services to publishers by establishing an intermediary between individual publishers and a number of CDN services and communication networks. In so doing, the invention can thereby provide a standard interface for content delivery, report generation, and payments that a publisher can use to access various CDN systems and/or communication networks that may each have unique procedures for handling these functions.

Selection of a particular content provider during a particular session according to the invention can be by any means known or yet developed. Selection may also be accomplished using techniques described in provisional patent application No. 60/186,054 filed Feb. 29, 2000 and other priority documents also incorporated herein by reference.

### OTHER FEATURES & BENEFITS

According to specific embodiments of the present invention, aspects of the invention can be embodied in a system referred to as TurboRoute™ to provide web businesses easier control over an increasingly complex content distribution environment. A service according to specific embodiments of the present invention provides maximum performance and flexibility to customers, including publishers and web hosting companies, with minimal effort required to implement and manage. According to specific embodiments, the present invention allows web hosting companies and site owners to register for and use acceleration services quickly and easily, with just a few steps required to begin distributing accelerated content—most of which can be done through a web interface. No re-working of web site content is required, and minimal re-mapping of URLs and files is involved.

According to further specific embodiments, the present invention can enable an end-user's own browser to choose the optimal delivery method for the site content across the existing web infrastructure and examines several possible choices for delivering the content: the original web site itself, proprietary servers or retargetters, and a number of content caching and delivery networks. The end-user's browser can facilitate selection of the route with the best response at that moment in time. The result, in almost every circumstance, is that the end-user experiences an improvement in delivery performance.

Hosting companies making decisions to deliver acceleration services must consider several competing imperatives on behalf of their publishers including cost control, content freshness, response to peak loads, and optimal delivery of particular data types. The present invention is built on a multi-dimensional architecture that enables policies that achieve improved content delivery within the context of these competing constraints. TurboRoute also supports easy and dynamic changes to those policies.

According to specific embodiments of the present invention does not impact the URLs that the end-user inputs and sees on their browser. The original look and feel of the Web site itself thus is maintained. The invention allows web site content creators to design sites that maximize the end-user experience and thus achieve the business goals driven by the web site owner. High-density graphics and other large files can be used with the assurance that the invention will manage delivery with the best possible performance.

According to further specific embodiments, monitoring and reporting are essential components of evaluating web site performance and measuring successful attainment of business objectives. TurboRoute provides aggregated usage information to assist in decision making on policy implementation for content distribution. Reports are also provided to demonstrate the improvement in response times. This is done by comparing the response times of the delivery method(s) used vs. the response times of alternate methods tested but not chosen.

Content Bride

Various aspects of the present invention may be further understood by consideration of (and in contrast to) services being proposed by “Content Bridge.” After the conception and first priority filing of the present invention, an industry group called “Content Bridge” was announced (formally on Aug. 23, 2000) as an alliance of web delivery service providers. Content Bridge was founded primarily by Inktomi, a marketer of scalable Internet infrastructure software, and Adero, a provider of content distribution services. Content Bridge is intended to facilitate content delivery at the edge of participating networks through content peering, which is described as allowing content to be delivered in a way that benefits every participant in the content delivery process.

Content Bridge has proposed, in general terms, a coalition service that will operate as follows:

1. A content provider in the Content Bridge network sends revised content to a host or content delivery network provider (CDN).

2. The hosting/CDN provider alerts the Content Bridge operator (the organization responsible for reporting and financial services) that content has been changed.

3. The operator updates all CDN and ISP edge caches. To provide billing and reporting services, the operator collects ‘anonymized’ usage data from the edge caches, including such things as number of cache hits, average response time, number of bytes transferred for each URL, and, in some cases, cache misses.

4. Information can then be forwarded to content providers. Content providers may receive either summary data or detailed log files that can be used for clickstream analysis.

According to Content bridge, host services will maintain control over relationships with content providers. Hosts will earn incremental revenue for every cache hit using their existing edge cache infrastructure. Content Delivery Networks are promised to extend their networks by accessing edge caches in networks in which they do not already have a presence. Content Providers are promised to gain visibility and control over content in edge caches, improve content performance for end users by distributing more types of content into a greater number of edge caches, receive valuable information about content usage and performance, and deliver content reliably via a trusted end-to-end service. Content providers do not join Content Bridge directly; instead, they may sign up for Content Bridge services through their hosting or CDN provider.

While these announcements are ambitious goals, specific methods and technology has generally not been disclosed. As one industry newsletter commented on Aug. 24, 2000 (Cracks in Inktomi's Content Bridge? by Jason Krause, Industry Standard)

So far, no one knows much about Inktomi's new technology. “We saw very little of substance,” says Akamai spokesman Jeff Young. “Nothing [Content Bridge] announced is currently available . . . . Inktomi says the technology is in testing now on AOL's network and will go live in early fall . . . [and] says the system will work better with more partners, and that more partners will join during the months to come. But outsiders wonder if this coalition can hold itself together. Inktomi is borrowing its model from the early days of ISPs, when providers would exchange traffic with one another to decrease network congestion. But squabbles soon broke out over whether or how to charge for the service. The results were fragmentation and headaches.

“The problem with coalitions is that they tend to get fragmented,” says Abhi Chaki, director of business development with Edgix, a content-delivery company set to launch in a month. “This is the same model but on the content side. And they're going to need a whole lot more partners if they want to bridge the gap between the end user and the content. They're going to need a lot more ISPs.”

Content Bridge, while hoping to combine caching operations of different providers, is proposing and testing a model based on coalitions of CDNs and ISPs, under control of hosting services, not of publishers. A coalition model has proven difficult to operate in the past.

The invention and various specific aspects and embodiments will be better understood with reference to the following drawings and detailed descriptions. In different figures, similarly numbered items are intended to represent similar functions within the scope of the teachings provided herein. In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention that are implemented on a computer, as will be understood from the teachings herein, may be implemented or accomplished using any appropriate implementation environment or programming language, such as C, C++, Cobol, Pascal, Java, Java-script, HTML, XML, dHTML, assembly or machine code programming, etc. All references, publications, patents, and patent applications cited herein are hereby incorporated by reference in their entirety for all purposes.

### BRIEF DESCRIPTION OF THE DRAWINGS

FIG. 1 illustrates a general method for providing content distribution network services to publishers.

FIG. 2 illustrates a method of providing CDN services to a publisher from a number of distribution sites.

FIG. 3 illustrates a method of forwarding acceleration policies to multiple CDNs.

FIG. 4 illustrates a method of managing payments for services provided to publishers according to specific embodiments of the invention.

FIG. 5A illustrates a method of managing and providing centralized reports for publishers according to specific embodiments of the invention.

FIG. 5B illustrates a method of managing and providing centralized reports for publishers according to specific embodiments of the invention.

FIG. 6 illustrates in more detail a method for providing content distribution network services to publishers.

FIG. 7 is a block diagram showing an example system related to aspects of the present invention.

FIG. 8 illustrates steps involved in example content acceleration.

FIG. 9 illustrates an example process of real-time performance measurements.

FIG. 10 is a block diagram illustrating a two-tiered system in a network providing intelligent content management according to specific embodiments of the invention.

FIG. 11A illustrates a block diagram of an example acceleration system according to specific embodiments of the invention.

FIG. 11B illustrates an alternative block diagram of an example acceleration system according to specific embodiments of the invention.

FIG. 11C illustrates an alternative block diagram of an example acceleration system according to specific embodiments of the invention.

FIG. 12 illustrates a block diagram of an example physical network retargetter architecture including redundant equipment according to specific embodiments of the present invention.

FIG. 13 is a block diagram showing a representative example logic device in which various aspects of the present invention may be embodied.

FIG. 14 is a block diagram of an example policy application module acceleration system according to specific embodiments of the invention.

FIG. 15 is a block diagram of an example aggregator module according to specific embodiments of the invention.

FIG. 16 is an illustration of an example graphical user interface, accessible using a standard web browser, allowing a customer/publisher to sign-up as a new user according to specific embodiments of the invention.

FIG. 17 is an illustration of an example graphical user interface, accessible using a standard web browser, allowing a customer/publisher to review and edit a new user profile according to specific embodiments of the invention.

FIG. 18 is an illustration of an example graphical user interface, accessible using a standard web browser, allowing a customer/publisher to create a new policy according to specific embodiments of the invention.

FIG. 19 is an illustration of an example graphical user interface, accessible using a standard web browser, allowing a customer/publisher to view an existing policy and to edit, delete, or copy an existing policy according to specific embodiments of the invention and including an optional warning that a policy state will be unscheduled if a policy is edited.

FIG. 20 is an illustration of an example graphical user interface, accessible using a standard web browser, allowing a customer/publisher to search for existing policies based on policy status according to specific embodiments of the invention.

FIG. 21 is an illustration of an example graphical user interface, accessible using a standard web browser, allowing a customer/publisher to view search results for existing policies based on policy status according to specific embodiments of the invention.

FIG. 22 is an illustration of an example graphical user interface for administration traffic menu selection allowing an authorized user to request a traffic report according to specific embodiments of the invention.

FIG. 23 is an illustration of an example graphical display of an administration traffic report according to specific embodiments of the invention.

FIG. 24 is an illustration of an example graphical user interface for traffic report option selection according to specific embodiments of the invention.

FIG. 25 is an illustration of an example graphical display of a user traffic report over all domains according to specific embodiments of the invention.

FIG. 26 is an illustration of an example graphical display of a user traffic report by URL according to specific embodiments of the invention.

FIG. 27 is an illustration of an example graphical display of an estimated billing statement according to specific embodiments of the invention.

FIG. 28 is an illustration of an example graphical user interface for administration performance menu selection allowing an authorized user to request performance reporting according to specific embodiments of the invention.

FIG. 29 is an illustration of an example graphical display of a retargetter acceleration report according to specific embodiments of the invention.

FIG. 30 is an illustration of an example graphical display of a retargetter acceleration report according to specific embodiments of the invention.

FIG. 31 is an illustration of an example graphical user interface for a user performance menu selection allowing an authorized user to request performance reporting according to specific embodiments of the invention.

FIG. 32 is an illustration of an example graphical display of a user performance report according to specific embodiments of the invention.

FIGS. 33A-D illustrate examples of customer database or data tables that may be used according to specific embodiments of the invention.

FIG. 34 is a block diagram showing steps in performing proximity cache service selection according to specific embodiments of the invention.

### DESCRIPTION OF SPECIFIC EMBODIMENTS

According to specific embodiments, the present invention extends and transforms the CDN model by providing an intelligent, dynamic decision making layer that automatically selects the fastest distribution path from a range of sources that include CDNs, the source Web site via traditional IP backbones, or a separately managed network of servers and or retargetters (e.g. the TurboRoute™ network). This ensures that each viewer gets the maximum possible acceleration.

1. General Methods For Providing Acceleration Services

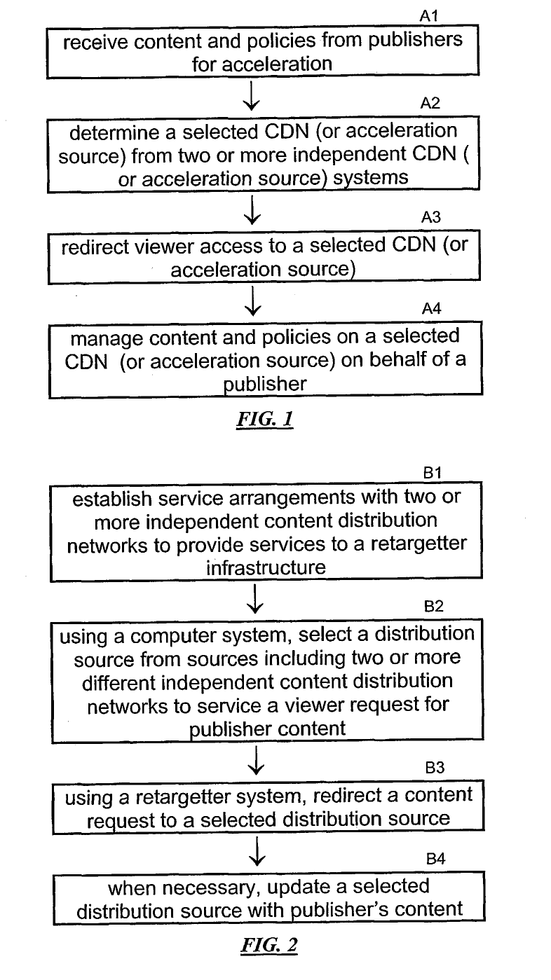

FIG. 1 illustrates a general method for providing content distribution network services to publishers. This method addresses the problem of how to deliver web content more quickly and effectively, given that there are different CDN providers with different cache systems or communication networks with different capabilities and that in typical publisher-CDN arrangements, a best-existing CDN may not be one to which a publisher subscribes.

To address this problem, the present invention involves a management function between various competing CDN systems and communication networks and publishers. In particular aspects, this management function selects a CDN source for viewer access and directs the viewer to that CDN and, when necessary, provides updated content and policies to that CDN on behalf of the publisher. This management function alone can provide greater acceleration performance and ease of use to publishers. Selection of a CDN and performance of other caching functions can be according to any known method of performing these functions, such as statistical performance measures of CDNs.

In a further aspect, however, this management function according to the invention can be viewed as involving a new business method for providing CDN services to publishers by establishing a management and/or payment intermediary between individual publishers and a number of independent CDN services. In so doing, the invention provides greater flexibility to publishers to, at different times and/or in different situations or circumstances, utilize CDN services from various independent providers. As will be understood from teachings herein, the invention can simplify publishers access to various CDN services by acting as a single source for one or more of managing acceleration policies, content distribution, and contract and payment arrangements. This source can also assist in managing acceleration policies and content distribution. Thus, the invention can provide publishers with decreased effort in using caching services while providing greater performance.

FIG. 1 illustrates a general method as follows: receiving content and policies from publishers for acceleration (Step A1); determining a preferred CDN from two or more independent systems (Step A2); redirecting viewer access to a preferred CDN (Step A3); and managing content and policies and on said CDN on behalf of a publisher (Step A4).

Note that in this example method, publishers establish a relationship with a single acceleration service, which acts as the intermediary, and the intermediary handles relationships with one or more CDN services and distributes acceleration or distribution requests to available distribution sources (at times referred to in the industry as edge caches). In specific embodiments, these distribution sources can be a variety of edge cache systems in a variety of different CDNs and can also include systems directly owned and managed by the intermediary. Thus, there is no need for a coalition-type relationship among CDN or ISP hosting servers. The intermediary acts as the original publisher as far as the competing CDNs are concerned, and the CDNs are paid by the intermediary for the aggregate services provided to the intermediary. The intermediary acts as a single CDN as far as publishers are concerned, and publishers can make a single arrangement with the CDN to initiate acceleration services and to set and manage acceleration policies. The intermediary is then responsible for translating acceleration policies to competing CDNs and to securing and managing service with different competing CDNs.

2. More Detailed Methods of Providing Acceleration Associated Services

According to specific embodiments of the invention, the present invention involves one or more novel methods of providing or facilitating various services associated with acceleration. FIG. 2 illustrates a method of providing CDN services to a publisher from a number of distribution sites. As show in the figure, the method include the steps of establishing service arrangements with two or more independent content distribution networks to provide services to a retargetter infrastructure (Step B1); determining a preferred CDN from two or more independent systems (Step B2); using a computer system to select a distribution source from sources including two or more different independent content distribution networks to service a viewer request for publisher content (Step B3); using a retargetter system, redirect a content request to a selected distribution source (Step B4); and when necessary, update a selected distribution source with publisher's content (Step B5).

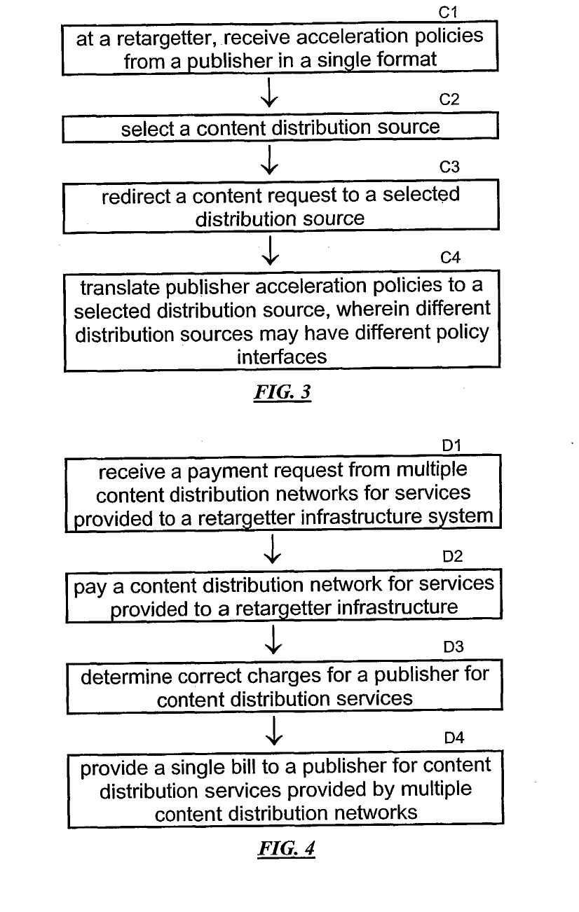

FIG. 3 illustrates a method of forwarding acceleration policies to multiple CDNs. As show in the figure, the method include the steps of at a retargetter, receive acceleration policies from a publisher in a single format (Step C1); selecting a content distribution source (Step C2); redirecting a content request to a selected distribution source (Step C3); and translating publisher acceleration policies to a selected distribution source, wherein different distribution sources may have different policy interfaces (Step C4).

FIG. 4 illustrates a method of managing payments for services provided to publishers according to specific embodiments of the invention. As show in the figure, the method include the steps of receiving a payment request from multiple content distribution networks for services provided to a retargetter infrastructure system (Step D1); paying a content distribution network for services provided to a retargetter infrastructure (Step D2); determining correct charges for a publisher for content distribution services (Step D3); and providing a single bill to a publisher for content distribution services provided by multiple content distribution networks (Step D4).

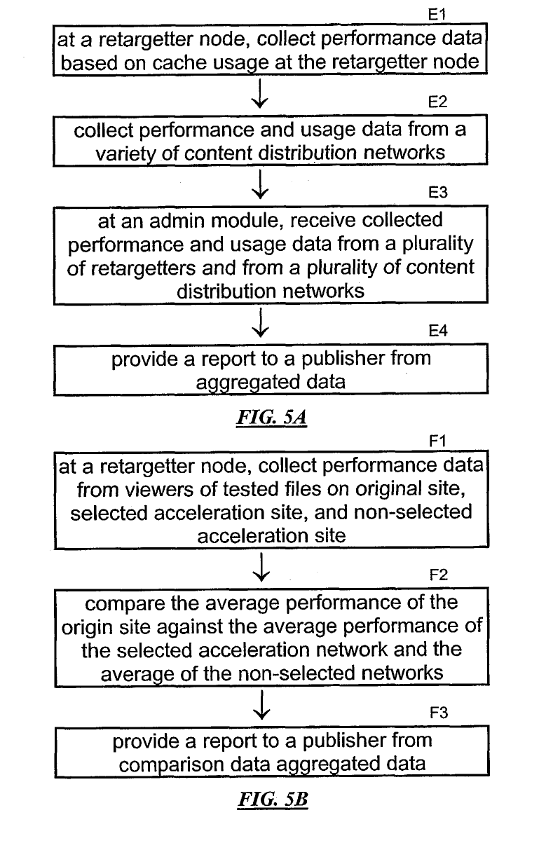

FIG. 5A illustrates a method of managing and providing centralized reports for publishers according to specific embodiments of the invention. As show in the figure, the method include the steps of at a retargetter node, collecting performance data based on cache usage at the retargetter node (Step E1); collecting performance and usage data from a variety of content distribution networks (Step E2); at an admin module, receiving collected performance and usage data from a plurality of retargetters and from a plurality of content distribution networks (Step E3); providing a report to a publisher from aggregated data (Step E4).

FIG. 5B illustrates an alternative method of managing and providing centralized reports for publishers according to specific embodiments of the invention. As show in the figure, the method include the steps of at a retargetter node, collect performance data from viewers of tested files on original site, selected acceleration site, and non-selected acceleration site (Step F1); compare the average performance of the origin site against the average performance of the selected acceleration network and the average of the non-selected networks (Step F2); and providing a report to a publisher from comparison data aggregated data (Step F3).

The present invention has thus far been described in terms of general embodiments. The previous description is believed to be a full and complete description sufficient to allow a practitioner in the art of content acceleration and caching to make and use the invention. It will be understood to those of skill in the art from the teachings provided herein that the described invention or components thereof can be implemented in a wide variety of specific programming environments and logical systems (such as UNIX, Windows, Solaris, Oracle, etc.) using a wide variety of programming languages (such as SQL, Visual Basic, Pascal, C++, Basic, Java, JavaScript, etc.) and wide variety of file formats.

What follows are descriptions of example systems and methods that are involved with or may embody various aspects of the present invention. This following discussion is included, in part, in order to disclose particularly preferred modes presently contemplated for practicing the invention. The following discussion may also include independent innovative embodiments of the invention. It is intended, however, that the previous discussion and the claims not be limited by examples provided herein. It is further intended that the attached claims be read broadly in light of the teachings provided herein. Where specific examples are described in detail, no inference should be drawn to exclude other examples or to exclude examples described or mentioned briefly from the broad descriptions of the invention provided herein. It is therefore intended that the invention not be limited except as provided in the attached claims and equivalents thereof.

3. Example Method Using End-User Executable Code

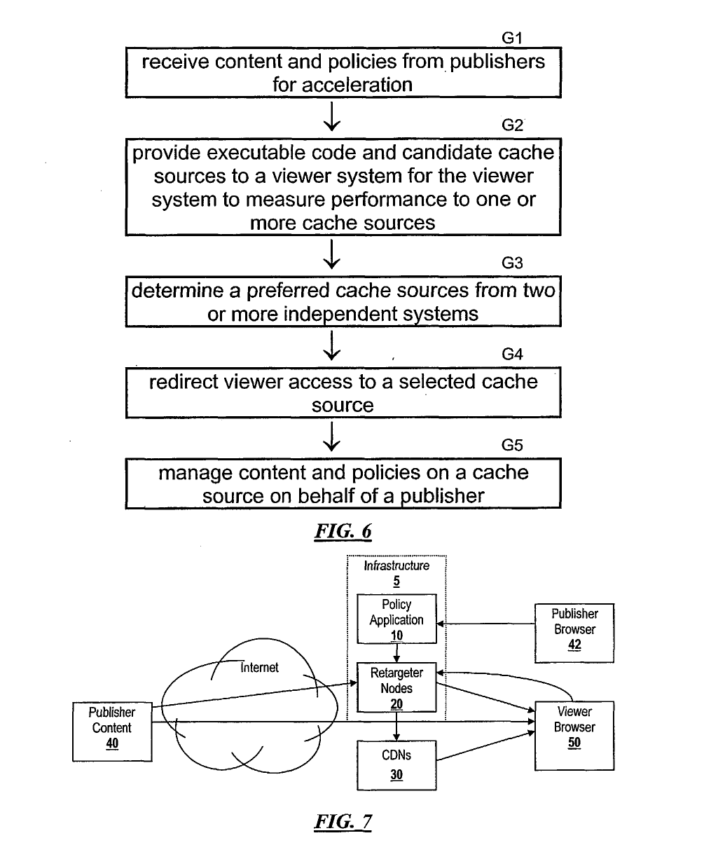

The present invention concerns business methods and payment centralization arrangements as herein described. However, aspects of the present invention can be better understood in the context of an example system for content acceleration. As one example of how such a system can facilitate selection of a CDN, consider FIG. 6. FIG. 6 illustrates a general method and illustrates receiving content and policies from publishers for acceleration (Step G1); providing executable code and data to a viewer system for the viewer system to measure performance to one or more CDNs (Step G2); determining a preferred CDN from two or more independent systems (Step G3); and managing content and policies and on a CDN on behalf of a publisher (Step G4). Note that in this example system, the problem of selecting among various independent CDNs is addressed by using a performance measure experienced by a requesting client as a parameter to guide in selection of a particular CDN source. While other parameters, such as varying CDN service costs, can be used in selecting a CDN for servicing a particular request, including an objective measure of competing CDN service performance provides is a way to guarantee to publishers that they are getting the best available service.

4. Further Aspects of Example Systems

In a further specific embodiment, the present invention involves one or more retargetter systems or retargetter functions to manage distribution of content from publishers to CDNs systems and to redirect viewer content requests to appropriate CDNs or CDN source.

In a particular embodiment, various aspects of the invention are included in a dynamic content distribution management service that can instantly accelerate the content of any web site. FIG. 7 is a block diagram showing an example system related to aspects of the present invention. This example comprises a web-based application 10 that accepts desired operating parameters such as publisher acceleration policies, viewer performance data, etc. This information is provided in real-time to a set of distributed retargetters 20. These retargetters can provide real-time rerouting of HTML pages (or other standard content format pages that may include locators, such as MS Word, VRML, RTML, etc.) to connect content 40 from a publisher's servers to the most desirable (such as that having the fastest response time or the least cost) content distribution network (CDN) 30 as determined either wholly or in part by each individual viewer.

In specific embodiments, real-time rerouting involves modifying content pages based on the acceleration policies set by the publisher and the real-time performance information. A conceptual diagram of this service is shown in FIG. 7. Requests for accelerated content pages are submitted to the retargetter, which then instructs the browser to obtain items from the retargetter, the publisher, or the “best” CDN.

A system as shown in FIG. 7 can accelerate a publisher's website in several ways. One example desirable method requires no DNS changes. An example detailed method, including a number of optional steps, works as follows: (1) The publisher opens his browser 42 and logs onto a policy application website. (2) The publisher then uses his browser to define an acceleration policy and (3) adds or modifies the publisher's home page redirecting viewer browsers to a retargetter. (4) In specific embodiments, a retargetter of retargetter nodes 20 provides the viewer's browser with performance measurement code that (5) contains a list of CDNs and/or CDN sources to be tested. (6) The viewer's browser measures response times from the supported CDNs and (7) reports this information back to the retargetter and the policy application server. (8) The retargetter retrieves content (such as HTML content) from publisher's servers, (9) modifies the content's URLs (or similar locators) in real-time based on the programmed policies and/or the measured performance information, (10) delivers the modified content to the browser, and (11) optionally caches in a local retargetter cache the modified HTML if applicable. (12) The viewers then retrieve the data from the locations indicated by the modified locators, which can indicate: a content server 40, one of retargetters 20, and/or one or more selected CDNs 30.

It will be understood from the teachings herein that the system thus described according to various embodiments can provide advantages comprising various combinations of the following:

Viewer can receive data from fastest responding cache or CDN (or CDN source) allowed under specified policies, regardless of CDN sources owned and managed by separate CDNs.

Because of the centralized role of the retargetters, it is possible to provide detailed unified usage reporting and analysis to publishers, even when using different CDN systems.

Because of the centralized role of the retargetters, it is also possible to centrally handle billing and service initiation, even when using different CDN systems.

Web site pre-processing is not generally required by publishers before publishing content to acceleration service.

Acceleration policies can be updated easily and quickly.

Access to various CDNs can be initiated easily and quickly.

DNS changes are optional.

No software requiring user intervention is necessary to install.

Content within dynamic pages can be accelerated because URL containing code from the publisher is modified in real-time, en route to the viewer. Therefore, even though the URL-containing code is generated in real-time, any static content indicated in that code can remain in a designated caching location.

No changes required at the publisher site to applications that generate dynamic HTML pages.

Furthermore, using an executable code component at a viewer computer, an original URL look and feel can be presented to viewers.

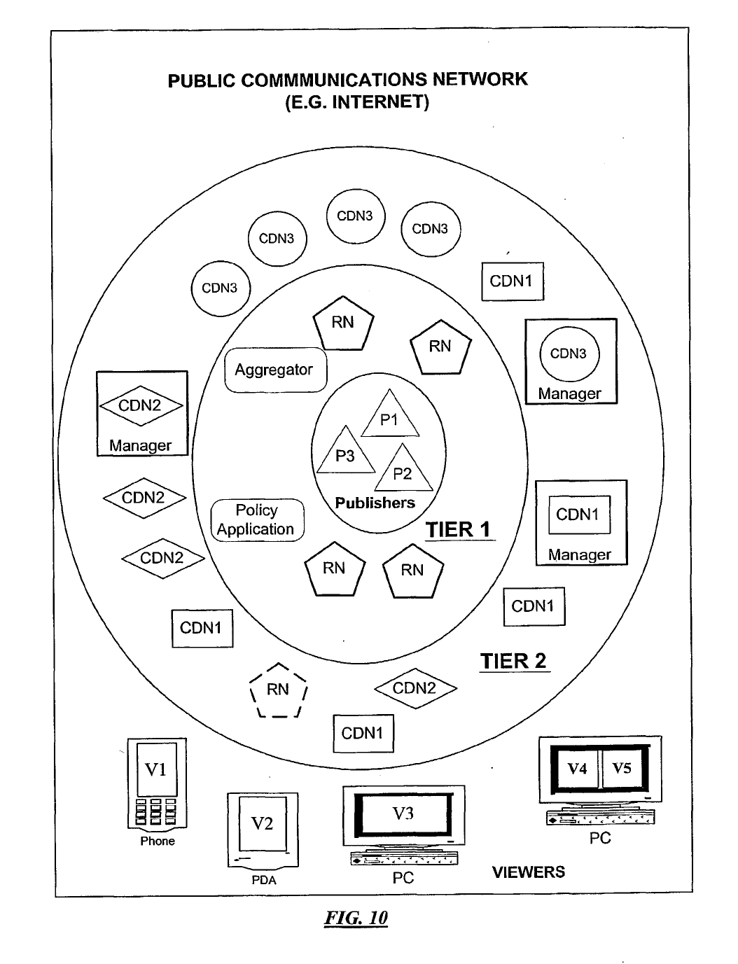

FIG. 10 is an alternative illustration of the system shown in FIG. 7 and will be understandable to practitioners in the art from the teachings provided herein. In FIG. 10, a system according to the invention is illustrated as a two-tiered system for providing accelerated content.

5. Initial Redirection (Frame Redirection or DNS Change)

In alternative embodiments, the invention may employ different methods for performing the initial redirection to a retargetter node. As examples, two methods that are sometimes used in the art may be employed according to the specific embodiments are listed in Table 3, along with some of their benefits and drawbacks.

TABLE 3
EXISTING GENERAL METHODS FOR
REDIRECTION AND MASKING URLS

| METHOD | BENEFITS | DRAWBACKS |
|---|---|---|
| (INVISIBLE) | Easy to setup; | Browsers are only |
| FRAME | Maintains site's URL look and | able to bookmark |
| REDIRECTION | feel; | the site's home |
| | No DNS changes required; | page |
| | Acceleration can be initiated is | |
| | controlled by a single web page | |
| | on original site; | |
| DNS | URLs look very similar to | Requires a DNS |
| CHANGE | original site; | change; |
| | Browsers can bookmark any page | |
| | within the site; | |

Publisher Convenience

In particular system embodiments, initiation of acceleration service can involve placing just two files on the publisher's web site: an HTML file that redirects the browser request to the acceleration infrastructure and kicks off the acceleration process; and a small test file (such as a GIF image file) used in performance testing for selection of a preferred Content Distribution Network and/or a preferred region. An example of such an HTML file is:

```
<!-- frame.html Copyright 2000 FastTide.com -->
<METAHTTP-EQUIV=“Refresh” CONTENT=“0;
URL=‘http://www.fasttide.net/www.testsite.com’”>
<html>
<head>
        <title></title>
        <META name=“Keywords” content=“”>
        <META name=“Description” content=“”>
</head>
<body>
</body>
</html>
```

In a further embodiment, a publisher can initially use frame-based acceleration to accelerate a site without delegation of a domain. This method utilizes a browser frame to hide from the viewer's display the domain name generated by the acceleration system. This method provides an easy way for publishers to try out the acceleration service. Once a publisher has determined that they want a more permanent acceleration service, a subdomain-based acceleration method can be used to accelerate a site using a subdomain delegated to the acceleration services by the publisher. Use of this method allows for easier and proper handling of cookies and deep bookmarks. There are two forms of this method. One in which a redirection page is required. The other does not require a redirection page; any request to the site is directed to the acceleration infrastructure.

6. Detailed Example Method for Acceleration Related to Specific Embodiments

FIG. 8 shows the steps involved in accelerating a site according to one example method according to specific embodiments of the present invention. Details of these interactions in this example are listed below. The circles on the flow arrows are placed near the source of the packet data described in the correspondingly numbered step.

1. A viewer's browser contacts a publisher's content server.

2. The publisher's server redirects the viewer to retargetter nodes. This can be accomplished using a variety of initial redirection methods as described herein. Further, according to specific embodiments of the present invention, a DNS resolver can optionally pick a retargetter closest to the browser and direct the browser to that particular retargetter. Thus, it will be understood that in typical embodiments, retargetter nodes 20 can include a number of retargetter nodes distributed throughout a communication network.

3. In specific embodiments, a retargetter provides initial code to the viewer browser directing the browser to participate in selecting a cache source.

4. According to specific embodiments of the present invention, the viewer's browser measures response times to one or more supported CDNs. As will be understood from the teachings herein, response time is generally measured to a CDN system as a whole. Where allowed by a CDN system, response times can also be measured to devices within a CDN system.

5. According to specific embodiments of the present invention, performance information is returned to the retargetter by the viewer browser. A cache source is selected, which according to specific examples can be selected by the viewer browser or by the retargetter using information from the viewer browser. The selected cache source can be a cache source device owned and managed by the retargetter nodes; one or more outside CDNs; or the retargetter itself.

6. The retargetter retrieves a requested HTML page (or other content containing resource locators) from the publisher's web site (or from the retargetter's local cache storage if it is available and fresh.)

7. The retargetter modifies appropriate contained URLs based on established acceleration policies and based on the selected CDN source and optionally caches the modified HTML pages. The retargetter then returns a modified page to the browser.

8. The browser retrieves content indicated by the URLs, some of which may have been translated by the retargetter. These translated URLs can indicate data from one or more selected CDNs, from the retargetter, or from the publisher's site, or from external data sources. Optionally, URLs indicating external data may be untranslated by the retargetter.

9. A content delivery network will, in turn, request pages and/or embedded content it does not already have from the retargetter. This may be done in accordance with a variety of CDN operating procedures, where, as far as the CDN is concerned the retargetter is the publisher. Thus, in one embodiment, a CDN never communicates directly with a publisher site.

10. A retargetter will in turn request pages and embedded data it does not have from the publisher's servers, and then provide those pages or embedded data to the CDN.

Note that in this method, the publisher needs no information about particular CDN components to which viewers are directed and may in fact be wholly unaware of which CDNs are being used to accelerate publisher content. Likewise, a CDN may never communicate with the publisher site and may view the retargetter as the original source for publisher content. A retargetter , according to the invention, may therefore both technically and/or from a business perspective, act as an intermediary, managing policy distribution, payment, and client access to a variety of CDNs on behalf of one or more publishers. This allows publishers to achieve a maximum acceleration based on a variety of available CDNs, without entering into numerous complex business arrangements and without keeping track of possible incompatible management interfaces with different CDN nodes. Thus in specific embodiments according to the invention, various aspects of the invention allow a system to manage CDN services from competing CDN sources on the fly and provide acceleration to web pages. In further embodiments, this further enables centralized payment, selection, and other functions provided by the retargetter.

7. Example Detailed Description of URL Translations That may be Associated With Specific Embodiments

The following is a description of the URLs displayed in Table 4 with respect to the steps being performed:

1. The viewer's browser contacts the publisher's content server at the publisher's normal URL (e.g. www.pub.com).

2. The publisher's server redirects the viewer to retargetters via techniques such as URL translation (e.g. fast.FastTide™.com/www.pub.com/ . . . ) or via a DNS name change to a name delegated to the retargetters by the publisher, e.g. www1.pub.com. In further embodiments, a DNS resolver may pick a retargetter closest to the browser and direct the browser to that particular retargefter, as would be understood in the art. In particular embodiments, the retargetter may provide the viewer's browser a page that contains performance measurement code, e.g. test_cdns.html.

In particular embodiments, the viewer's browser may measure response times to the supported CDNs using the URLs shown for step 4. There can be different forms of the request depending upon whether the CDN itself is a DNS-based or directory-based CDN. In various embodiments, performance information can be returned to the retargetter to aid in selecting an optimal CDN, or a CDN can be selected by the viewer.

5. A selected CDN can be indicated using different translations in different forms of URL, as shown in step 5.

6, 10. The retargetter retrieves the requested HTML page from the publisher's web site.

7. The retargetter modifies contained URLs (using HTMLRouting) indicating embedded content based on the acceleration policy and selected CDN. The retargetter optionally may cache the modified HTML pages. URLs to other HTML pages are redirected to the retargetter, indicating the previously selected cache source (e.g. fast.FastTide™.com/www.pub.com/cdnx/ . . . OR cdnx.fast.FastTide™.com/www.pub.com/cdnx/ . . . OR www1.pub.com/cdnx/ . . . ). Generally, external links are unchanged. URLs to embedded content supported or accelerated by the retargetter or the CDNs are changed to an appropriately formatted URLs for the particular cache source. The retargetter returns the modified pages to the browser.

8. The browser retrieves subsequent URLs based on the modified pages. These URLs may indicate the selected content delivery network, the retargetter, the publisher's site, and/or external locations. Note that URLs of the form FastTideT™.cdnx.com/www.pub.com/ . . . are hosted at the CDN site and are generally “owned” by the CDN. The exact format of URLs to a particular CDN can vary based on the requirements of the different CDNs and a retargetter according to the present invention can comply with a variety of CDN specified URL formats. As an example, the actual URL provided as a redirect to embedded content at the zoomzoom CDN might have the form www.zoomzoom.net/www.FastTide™.com/pub.com/ . . .

9. The content delivery networks may in turn request pages they do not already have from the retargetter.

10. The retargetters may in turn request pages they do not already have from the publisher's servers.

Table 4 displays sample incoming and outgoing link translations for each type of source and relates those translations to the steps shown in FIG. 8. Various types of CDN translation links can be supported in different systems. As an example, there are two types of commonly used translation links, as will be generally understood in the art: DNS-based and directory-based.

With a directory-based translation, the CDN path and any CDN directory structure is indicated in the translated URL, along with an indication of the URL of the original data. This translation can be in different forms, such as, for example fast.FastTide.com/www.publisher.com/cdnx/ . . . or cdnx.fast.FastTide.com/www.publisher.com/ . . . . With DNS-based translation, the DNS name of the original server is replaced with a DNS name indicating the CDN. Both of these types of CDN links are shown in the table and can be supported according to the invention. An example retargetter can dynamically support both types of CDN and other CDNs and dynamically deliver translated URL pages appropriate for a particular selected CDN.

As discussed above, the initial redirection can be accomplished either through a frame-based translation/redirection or through redirection using DNS acceleration or through other known or developed redirection methods. With the DNS acceleration, the publisher website delegates a sub-domain to a central content manager. In the table below, for example, www1.pub.com has been delegated by the publisher to a retargetter address, (such as FastTide™).

TABLE 4
EXAMPLE URL TRANSLATION

| Source/Destination | | | |
|---|---|---|---|
| (i.e. | | | |
| network element | | | |
| involved) | Step | Direction (comment) | URLs |
| Publisher | 1 | In from Browser | www.pub.com |
| | 2 | Out to Browser (initial | |
| | | redirect to retargetter) | |
| | | Retargetter via | fast.FastTide.com/www.pub.com/test_cdns.html |
| | | URL translation | |
| | | Retargetter via | www1.pub.com/home.html |
| | | DNS change | |
| Retargetter | 5 | In from Browser | |
| (in this example | | (selecting cdnx as | |
| named FastTide) | | cache source) | |
| | | Retargetter via | fast.FastTide.com/www.pub.com/cdnx/... OR |
| | | URL Translation | cdnx.FastTide.com/www.pub.com/... |
| | | | (This second form is more compatible with |
| | | | some JAVA components.) |
| | | Retargetter via | www1.pub.com/cdnx/... OR |
| | | DNS change | cdnx.www1.pub.com/... |
| | 6, 10 | Out to Publisher | www.pub.com/... |
| | 6, 10 | In from Publisher | www.pub.com/... |
| | 7 | Out to Browser | |
| | | (to html content) | |
| | | Retargetter via | fast.FastTide.com/www.pub.com/cdnx/... OR |
| | | URL Translation | cdnx.fast.FastTide.com/www.pub.com/... |
| | | Retargetter via | www1.pub.com/cdnx/... |
| | | DNS change | |
| | 7 | Out to Browser (to | Unchanged |
| | | external links) | |
| | 7 | Out to Browser (to | fast.FastTide.com/www.pub.com/... |
| | | embedded content, | |
| | | selected Cache Source | |
| | | is Retargetter) | |
| | 7 | Out to Browser (to | FastTide.cdnx.com/fast.FastTide.com/ |
| | | embedded content, | www.pub.com/... |
| | | selected Cache Source | |
| | | is CDNx-dir) | |
| | 7 | Out to Browser (to | cdnx.FastTide.com/www.pub.com/... |
| | | embedded content, | |
| | | selected Cache Source | |
| | | is CDNx-dns) | |
| CDNx-dir | 4, 8 | In from Browser | cdnx |
| | | | FastTide.comfast.FastTide.com/www.pub.com/... |
| | 9 | Out to Retargetter | fast.FastTide.com/www.pub.com/... |
| | 9 | In from Retargetter | no further urls |
| | ... | Out to Browser | no further urls |
| CDNx-DNS | 4, 8 | In from Browser | FastTide.cdnx.com/www.pub.com/... |
| | 9 | Out to Retargetter | fast.FastTide.com/www.pub.com/... |
| | 9 | In from Retargetter | no further urls |
| | ... | Out to Browser | no further urls |

As will be understood from the teachings herein to practitioners in the art, real-time HTML routing may be used to optimize such things as: CDN Performance; Bandwidth costs; Data freshness; Allocation of time-of-day bandwidth; Selection of data types per CDN; CDN Availability; etc.

8. Performance Measures

In specific example systems, real-tine performance measurements can be used to determine which CDN is performing the best for each given viewer and data is retargetted to the CDN with the best performance. Many different performance selection criteria can be used. A simple method measures only the current session's performance. A more sophisticated method performs a weighted averaging including the results of previous performance measurements and/or performs a statistical predictive analysis. The performance statistics are gathered and analyzed to provide publishers with performance reports. Selection can also include cost or other factors.

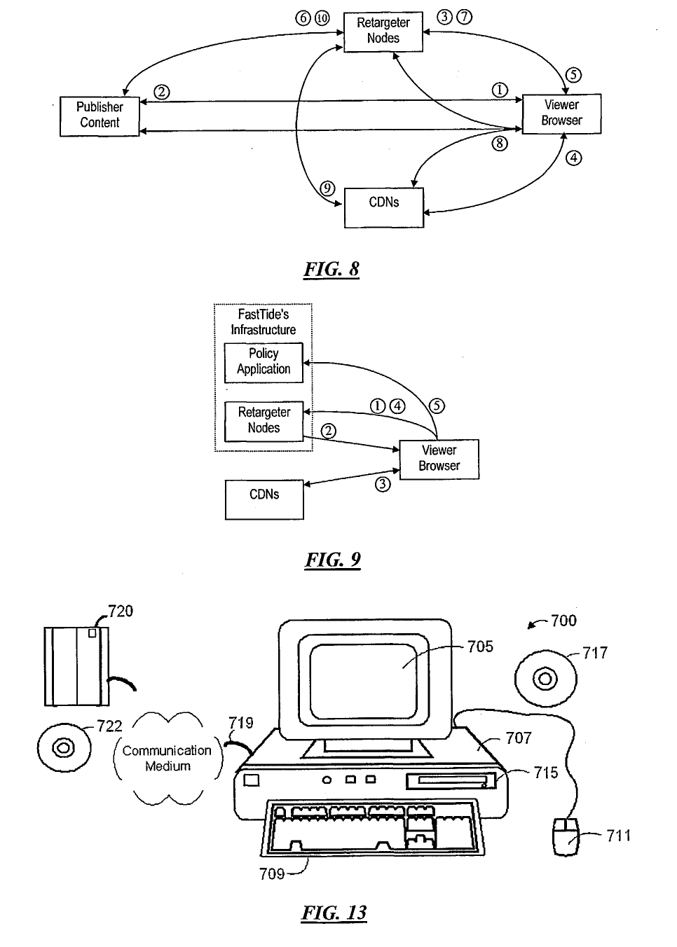

FIG. 9 displays how the real-time performance measurements are accomplished according to one embodiment. These steps are listed below:

1. After the publisher redirects the viewer to the retargetter location, the browser requests a CDN-neutral URL. The retargetter determines that the viewer's browser has not selected a CDN based on the requested URL.

2. The retargetter sends the CDN performance measurement and selection code to the browser. This code can be delivered to the viewer using one of several methods. These include JavaScript, Java applets, COM files, and/or plug-ins, etc.

3. The browser runs the code and performs the response time measurements.

4. The browser reports the results to the retargetter through a predefined, CDN-specific URL mapping. In other words, in particular embodiments, the browser indicates a selected CDN by requesting from the retargetter a URL including data indicating that CDN.

5. The browser in specific embodiments may also transmit the results of the performance measurements to the retargetter for further analysis and reporting.

If a CDN's charges are based on 95% bandwidth, real-time measurements can be used to determine CDN loads and more traffic can be routed to CDNs that are lightly loaded. This process allows a retargetter to optimize its costs, which can be passed on as savings to its customers. In further embodiments, the retargetter can manage maximum cache expiry times and other caching parameters to ensure freshness of the publisher's content. In further embodiments, customers (e.g. publishers) may schedule bandwidth on demand for promotional events. In other embodiments, different data types may be routed to different CDNs depending upon the capabilities of those CDNs. As another advantage according to the invention, customers are automatically routed to other CDNs if a CDN becomes unavailable or unreachable for some reason.

In one example system, performance can be measured by requesting a small file located at the publisher site from multiple CDNs and selecting the fastest responding CDN. Generally, the response to request time is the primary bottleneck for CDN performance, rather than the time to transmit the data once a session has been established. In experimental tests, it has been found that the CDN the responds the quickest in the initial request tests provides the best performance approximately 85% of the time. In a further embodiment, a selection method can utilize the historical running average to select the best CDN for a particular viewer session, which has been found to correlate very highly with the best actual CDN in terms of performance.

9. Communication Network Selection

In a further example embodiment, an example system can use one or more retargetter systems or functions to manage distribution of content from publishers directly to viewers on one or more communication networks and to redirect viewer content requests to the appropriate communications network. In this embodiment, for the purposes of CDN selection and performance measuring, the retargetter infrastructure can be considered another CDN to be tested. When a retargetter is selected, or when the retargetter is serving content that is not being accelerated by the CDNs, the retargetter acts as a communications network switching point. The retargetters are placed in networks such that they have direct connectivity and routes to major backbones on the Internet. The routing tables in routers connecting the retargetter are constructed in such a way that a vast majority of viewers trying to reach the retargetter traverses only one Internet backbone. Additionally, the retargetter is usually only one Internet backbone away from a vast majority of publisher sites. With this routing arrangement, the retargetter acts as an Internet backbone switch, moving the content from the publisher's backbone to the viewer's backbone through private links between the backbones.

10. Two-Tiered System for Intelligent Content Management

From the teachings provided above, it will be understood to those of skill in the art that aspects of the present invention can also be understood and described as involving a Two-Tiered Intelligent Content Management System. FIG. 10 is a block diagram illustrating a two-tiered system in a network providing intelligent content management according to specific embodiments of the invention. FIG. 10 illustrates a conceptual public network space, with a number of publishers (P), a number of retargetter devices (or retargetter nodes, RN) existing in a first tier, along with associated retargetter system modules such as an aggregator (AGG) and policy application (PA), a number of different CDN systems, with various cache devices and each having a CDN management device, and a number of viewers. FIG. 10 can be understood as a network configuration, where all devices shown are understood to be modules able to communicate over the network.

As shown in FIG. 10, according to specific embodiments of the invention, to establish and during acceleration services, publisher sites (P) primarily communicates with first-tier content management devices and is insulated from interacting with various second tier devices. The second-tier devices, likewise, receive content and direction from the first tier devices.

11. Other Example System Embodiments

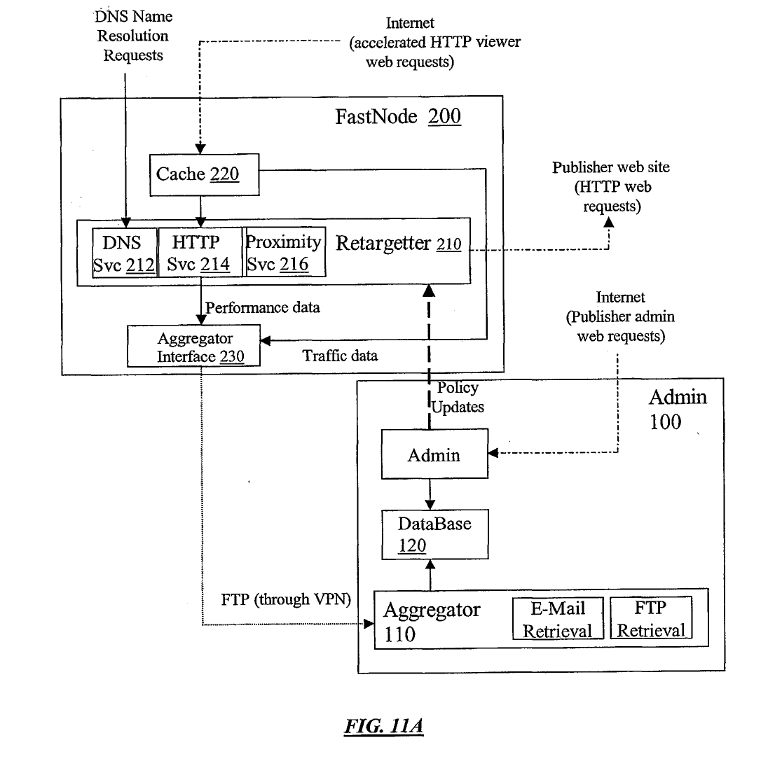

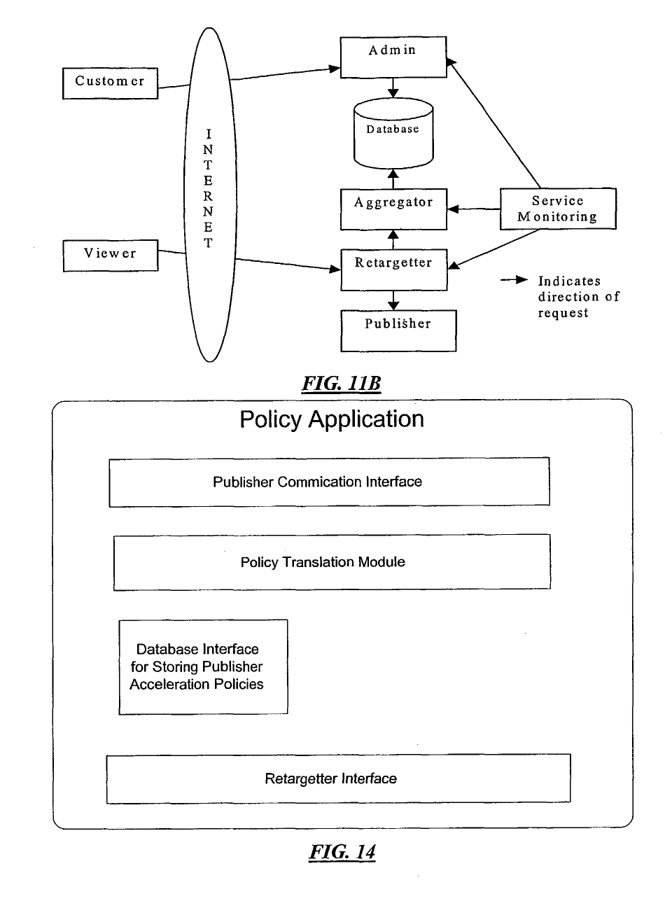

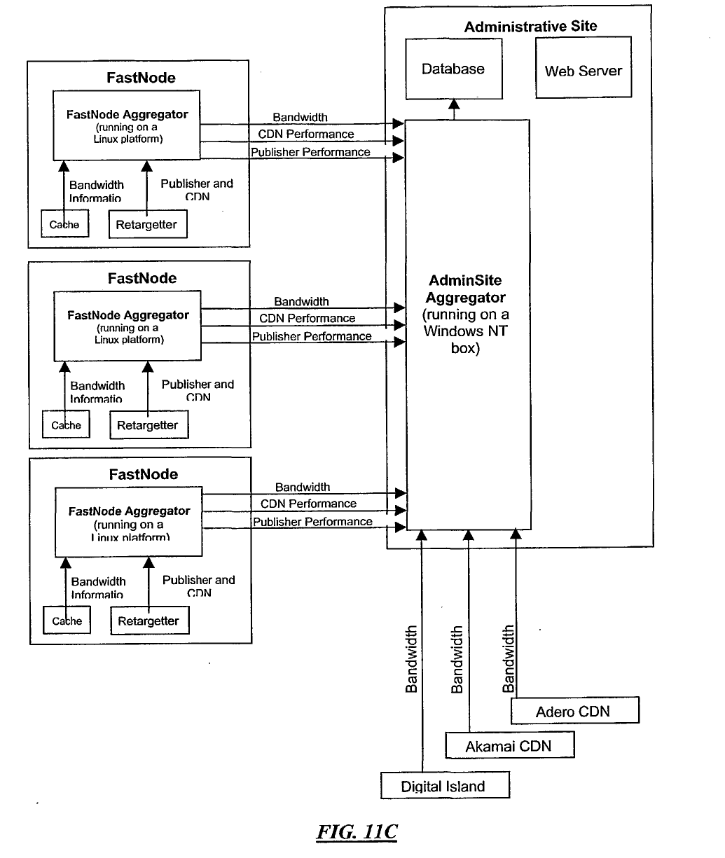

Aspects of the present invention, can be further understood as involving a logic system having a variety of specific example logic modules. What following are descriptions of a specific example system according to specific embodiments of the invention. This specific example system can be understood as including three principal types of logic modules, referred to in this example as Admin, Retargetter 210, and Aggregator 110, and other modules and functions as discussed below. In a particular product according to the invention, these components work together to provide capabilities necessary to manage publisher profiles, accelerate publisher sites, collect and report on performance and usage statistics and handle billing. Details of these components are described below and illustrated in FIG. 11. FIG. 11A illustrates a block diagram of an example acceleration system according to specific embodiments of the invention. FIG. 11B illustrates an alternative block diagram of an example acceleration system according to specific embodiments of the invention. This discussion is provided to give further examples of systems built according to the invention, but is not intended to limit the general description of the invention as described elsewhere herein.

FIG. 11C illustrates an alternative block diagram of an example acceleration system according to specific embodiments of the invention.

Further, in specific embodiments, a retargetter node according to specific embodiments of the invention may consist of a collection of cooperating hardware platforms designed to accelerate web content. In a particular example implementation, a retargetter node includes devices such as the following. Brand and model identification are for example purposes only, and many other configurations of components are possible according to specific embodiments of the present invention.

TABLE 5
FASTNODE ™ OR
FASTSITE ™ EXAMPLE DEVICES

| Device | Brand | Model |
|---|---|---|
| Layer 4 switch | Arrowpoint | CS/800 |
| Firewall | Netscreen | Netscreen |
| Cache Server | Network Appliance | Netcache |
| Retargeter Host (TidalStream | Compaq | Proliant |
| Retargeter) | | |
| Log aggregator | Compaq | Proliant |

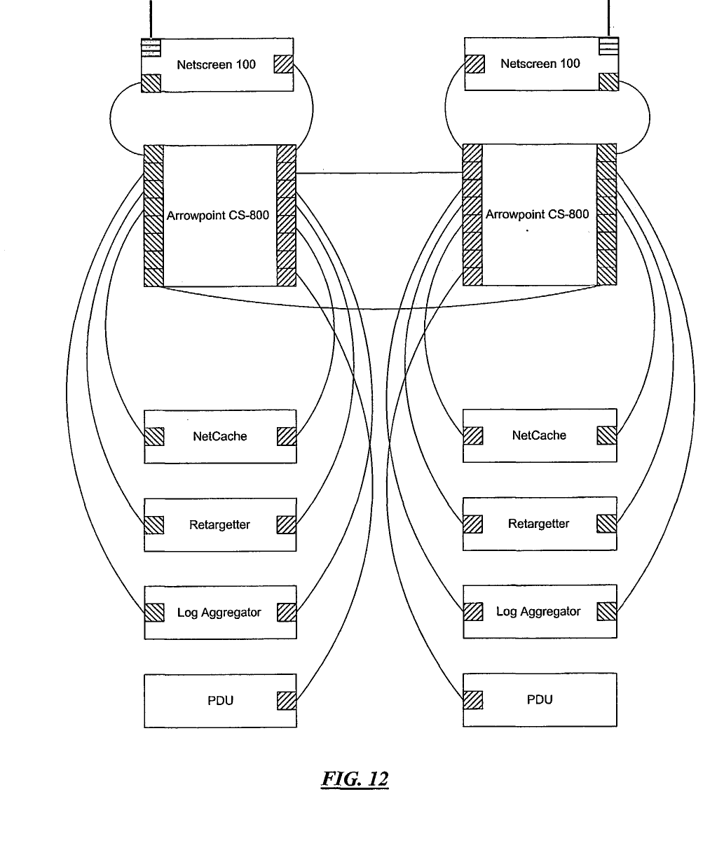

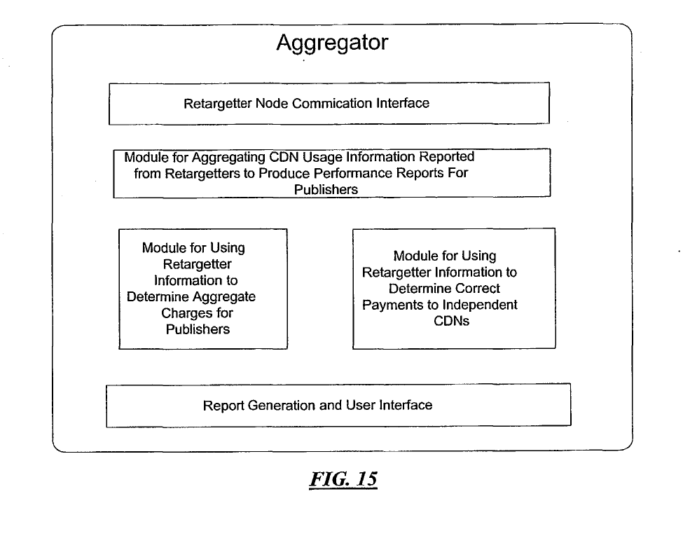

Further, each retargetter can have a public network and a private network. The public network uses addresses assigned by the respective hosting or collocation facility. All public addresses will be assigned to virtual IP (VIP) servers. The private network follows an internal addressing scheme. A example architecture can be configured as shown in FIG. 12. This figure illustrates redundant equipment according to specific embodiments of the present invention.

Generally, retargetters are made up of the same general devices. The devices are, an L4 switch, a cache, a retargeter, a log aggregator and a power distribution unit.

12.Admin Equipment

Table 5 provides a brief functional overview of the network elements and servers in an admin node.

TABLE 6
NETWORK ELEMENTS AND SERVER DESCRIPTION

| EOP | EQUIPMENT | DESCRIPTION |
|---|---|---|
| agg | aggregator | The aggregators collect usage data from FastTide': |
| | | retargetter nodes and from the CDNs. |
| app | application server | The application server runs the web logic application and |
| | | web server software. It hosts FastTide's web site as well as |
| | | the admin application. Both the presentation and the |
| | | business logic layer of the application are performed on |
| | | this server. |
| dbs | database | The database provides the persistence layer for the admin |
| | | application. It also accepts all the usage data from the |
| | | aggregators. |
| dns | domain name server | The DNS servers provide name-to-IP mappings for all o |
| | | FastTide's domains. |
| fwl | firewall | The firewalls provide stateful inspection of all traffic to the |
| | | admin node and provide VPN access to the backend |
| | | network. |
| lbs | load balancing switches | The load balancing switches provide both global and local |
| | | server loadbalancing, and NAT. |
| pdu | power distribution unit | The pdu provides remote operable power switches, and |
| | | console connections to all the servers. Remote access to the |
| | | pdu is via TDM and 33 Kbps physical modems. |

13. Admin Module Overview

An ADMIN component provides key business logic and user interface components used by publishers and accelerator administrators to maintain aspects of publisher accounts. According to specific embodiments, ADMIN is web-based and can provide user interfaces via browsers. According to specific embodiments of the invention, the ADMIN User Interface supports a variety of services such as those described below and elsewhere herein.

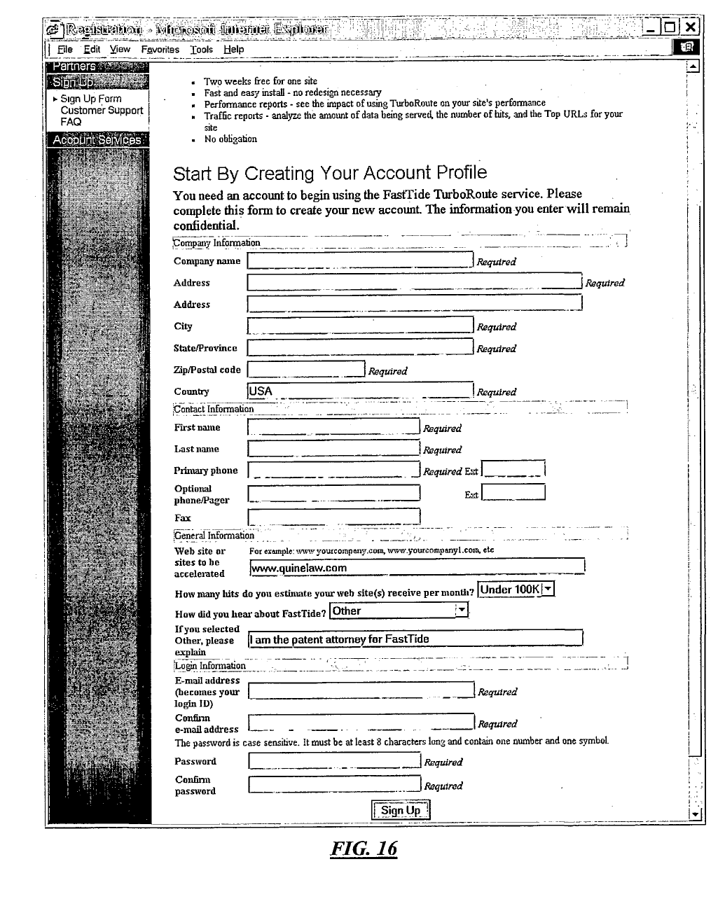

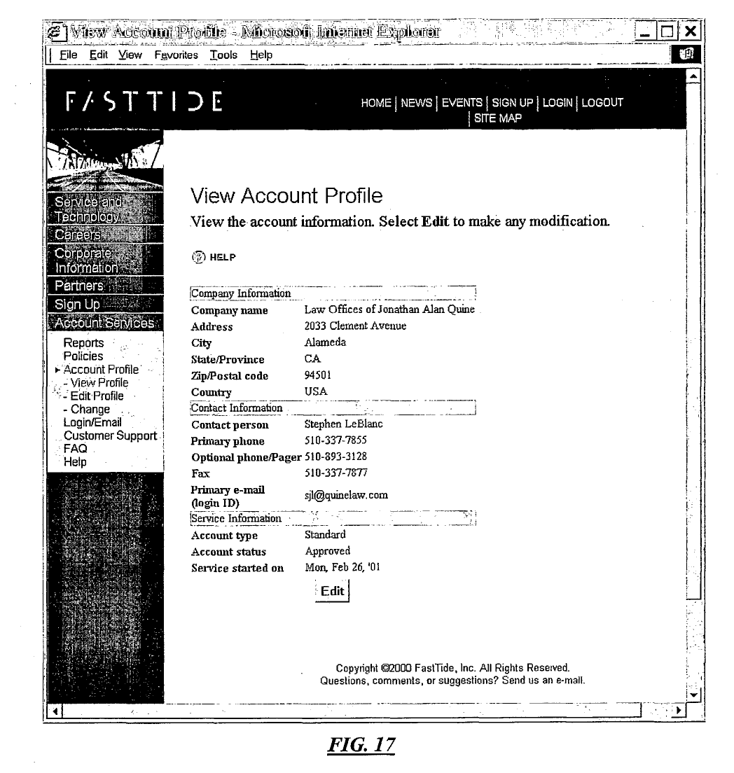

New publishers/users create accounts using an Account Registration Interface. The user provides company and contact information and agrees to the terms of the service through this interface. A Publisher Profile Management Interface may be provided to allow changes to publisher information. A User Profile Management Interface may be provided to allow changes to the user's contact information. FIG. 16 is an illustration of an example graphical user interface, accessible using a standard web browser, allowing a customer/publisher to sign-up as a new user according to specific embodiments of the invention. FIG. 17 is an illustration of an example graphical user interface, accessible using a standard web browser, allowing a customer/publisher to review and edit a new user profile according to specific embodiments of the invention.

14. Policy Management By Publishers

In further examples, a system provides an easier way for a publisher to manage cache policies by providing a policy application that resides on a remote infrastructure. A publisher may then access and interact with this policy application using a standard interface, such as a standard web browser, an email client, or other standard interface. Some prior art systems, in contrast, generally require publishers to manage cache policies locally at the publisher site and therefore require a policy application that must be installed and run locally.

Publishers are provided with a user interface for creating policies for web sites to be accelerated, managing content freshness through the use of caching time-to-live attributes, and other attributes necessary to execute the acceleration process. According to specific embodiments of the invention, policies are defined using an XML data representation. Policies are scheduled and may be characterized for example as any of the following states:

1. Draft—All policies being edited are in the draft state. These policies may be copied, edited, deleted, or scheduled.

2. Scheduled—Scheduled policies are placed in an activation queue. The specified web site is validated at the time a policy is scheduled. Scheduled policies may be copied, edited or deleted.

3. Activated—A policy is activated when its scheduled activation time is reached. Activated policies may be copied or expired. In specific example systems, only one policy may exist per site.

4. Expiring—Policies may be selected for termination and added to an expiration queue. Expiring policies may be copied or re-Activated.

5. Expired—A policy that finally is expired. These policies may only be copied.

6. Disabled—During the scheduling process conflicts with a policy may be encountered. When this occurs, the policy is Disabled. These policies may be edited, deleted or copied.

According to specific embodiments of a system, policies may be created with one of two kinds of acceleration methods—Frame-based or sub-domain based—described elsewhere herein. A frame-based acceleration method is used to accelerate a site without delegation of a domain. This method utilizes a browser frame to hide from the viewer's display the domain name generated by the acceleration system. This method provides an easy way for publishers to try out the acceleration service. A subdomain-based acceleration method is used to accelerate a site using a subdomain delegated to FastTide™ by the publisher. Use of this method allows for easier and proper handling of cookies and deep bookmarks. There are two forms of this method. One in which a redirection page is required. The other does not require a redirection page; any request to the site is directed to the acceleration infrastructure.

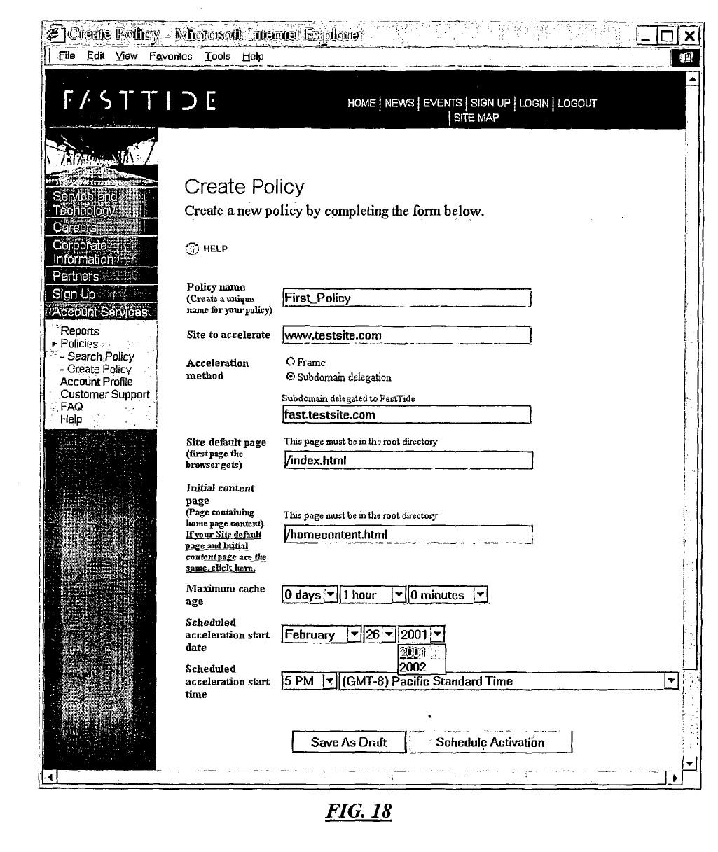

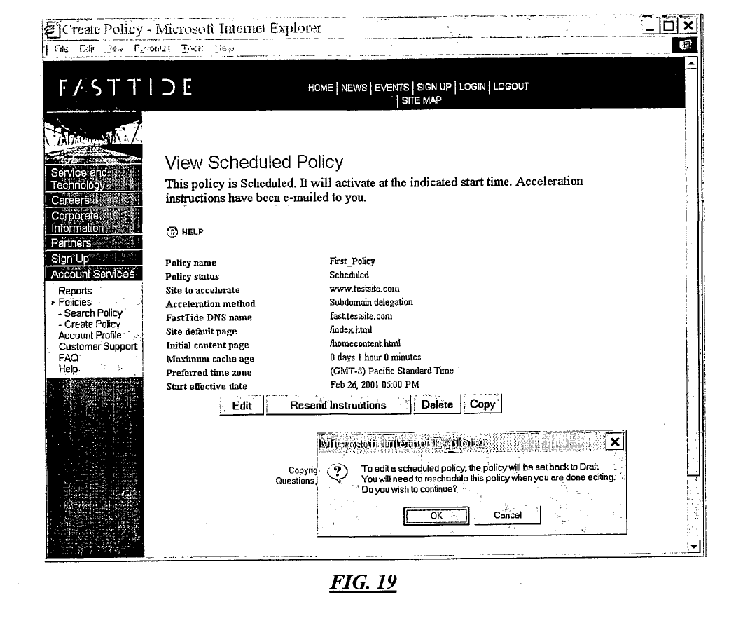

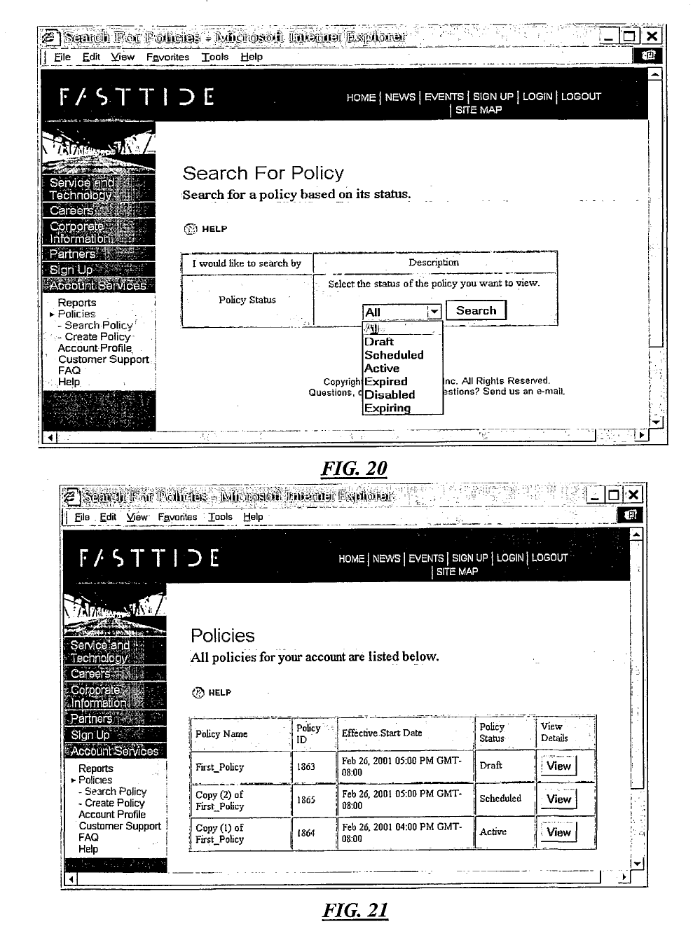

FIG. 18 is an illustration of an example graphical user interface, accessible using a standard web browser, allowing a customer/publisher to create a new policy according to specific embodiments of the invention. FIG. 19 is an illustration of an example graphical user interface, accessible using a standard web browser, allowing a customer/publisher to view an existing policy and to edit, delete, or copy an existing policy according to specific embodiments of the invention and including an optional warning that a policy state will be unscheduled if a policy is edited. FIG. 20 is an illustration of an example graphical user interface, accessible using a standard web browser, allowing a customer/publisher to search for existing policies based on policy status according to specific embodiments of the invention. FIG. 21 is an illustration of an example graphical user interface, accessible using a standard web browser, allowing a customer/publisher to view search results for existing policies based on policy status according to specific embodiments of the invention.

According to further specific embodiments of the present invention, once a policy is established, various changes made to established policies can be communicated to a publisher via email notification. The examples below illustrate various example email communications that can be used to communicate with a publisher to allow for easy management of acceleration policies. As will be seen in the examples, while most notifications to users are simple and while user initiation can be simple, designation of a subdomain to the retargetter site may require several actions each time a subdomain is designated.

### EXAMPLE 1

### Example Email Indicating Policy Status Change

-------------------------Begin Example 1 Email-------------------------

| | |
|---|---|
| From: | policyadmin@fasttide.com |
| Sent: | Monday, February 26, 2001 3:09 PM |
| To: | sjl@quinelaw.com |
| Cc: | policyadmin@fasttide.com |
| Subject: | TurboRoute Policy was Unscheduled (1863/1635) |

The following TurboRoute policy has been unscheduled.

| | |
|---|---|
| Policy name: | First_Policy |
| Scheduled start time: | Feb 26, 2001 05:00 PM GMT-08:00 |
| Previous status: | SCHEDULED |

This policy may be edited and rescheduled at your
convenience. If you have any

questions or think you have received this email in error, please
contact Customer Support.

-------------------------End Example 1 Email-------------------------

### EXAMPLE 2

### Example Email Indicating Policy Expiration

-------------------------Begin Example 2 Email-------------------------

| | |
|---|---|
| From: | policyadmin@fasttide.com |
| Sent: | Monday, February 26, 2001 4:58 PM |
| To: | sjl@quinelaw.com |
| Cc: | policyadmin@fasttide.com |
| Subject: | TurboRoute Policy has Expired (1864/1754/1635) |

The following TurboRoute policy has Expired:

| | |
|---|---|
| Policy name: | Copy (1) of First_Policy |

| | |
|---|---|
| Scheduled start time: | Feb 26, 2001 04:00 PM GMT-08:00 |

Please confirm that you have replaced this Expired policy with another Active policy to

ensure that the TurboRoute service continues to operate properly for your site.

If you do not have an active policy, then please immediately remove the redirection file

from your Site default page and replace it with your home content page. Your site will not
function properly otherwise. If you have any questions or think that you have received
this e-mail in error, please contact Customer Support.

-------------------------End Example 2 Email-------------------------

### EXAMPLE 3

### Example Email Containing Configuration Instructions for Subdomain Delegation

------------------------------Begin Example 3 Email------------------------------

| | |
|---|---|
| From: | policyadmin@fasttide.com |
| Sent: | Monday, February 26, 2001 3:06 PM |
| To: | sjl@quinelaw.com |
| Cc: | policyadmin@fasttide.com |
| Subject: | TurboRoute Subdomain-based Acceleration Configuration |
| | Instructions (1863/1635) |

Your policy has been successfully entered into our system and scheduled for activation:

| | |
|---|---|
| Policy name: | First_Policy |
| Scheduled start time: | Feb 26, 2001 05:00 PM GMT-08:00 |

Below, please find a copy of the configuration instructions you will need to follow when

your policy becomes active. Please take a moment to familiarize yourself with these instructions
prior to your policy's activation. Another copy will be forwarded to you when your policy is
activated. At that time, please perform the actions provided in the instructions. Within the
instructions, you will find references to two file attachments: an HTML redirection file and a
fasttide.gif file. These two files will be e-mailed to you when your policy is activated. If this is
the first time you have created a TurboRoute policy, you will need to install these files on your
site before the TurboRoute service can operate correctly.
SUBDOMAIN-BASED ACCELERATION CONFIGURATION INSTRUCTIONS TO
PERFORM WHEN YOUR POLICY BECOMES ACTIVE.

These instructions are based on the following policy definition that you created for your

site when you logged into FastTide Account Services:

| | |
|---|---|
| Policy name: | First_Policy |
| Site to accelerate: | www.testsite.com |
| Subdomain delegated to FastTide: | fast.testsite.com |
| Site default page: | /index.html |
| Initial content page: | /homecontent.html |
| Maximum cache age: | 0 days, 1 hours, 0 minutes |
| Scheduled start time: | Feb 26, 2001 05:00 PM GMT-08:00 |

Section A. DELEGATING YOUR DOMAIN TO FASTTIDE

Please perform the following steps if your policy uses the subdomain-based acceleration

method. If available, enlist the help of your Domain Name Administrator to complete the
following steps. If you do not know who your administrator is, please go to
http://www.networksolutions.com and perform a Who Is search for your site.
Step A1. Login to your primary DNS server machine with privilege sufficient to change the

BIND configuration.

Step A2. Change your directory location to the one containing the DNS zone configuration file

for your domain.

Step A3. Open the DNS zone file for editing using a text editor.
Step A4. Increment the serial number contained in the DNS zone file.
Step A5. Delegate the fast.testsite.com to FastTide by adding the following entries to your DNS

zone file:
fast.testsite.com. 300 IN NS ns01.p.fasttide.net.
fast.testsite.com. 300 IN NS ns02.p.fasttide.net.
fast.testsite.com. 300 IN NS ns03.p.fasttide.net.
fast.testsite.com. 300 IN NS ns04.p.fasttide.net.
fast.testsite.com. 300 IN NS ns05.p.fasttide.net.
fast.testsite.com. 300 IN NS ns06.p.fasttide.net.
fast.testsite.com. 300 IN NS ns07.p.fasttide.net.
fast.testsite.com. 300 IN NS ns08.p.fasttide.net.
fast.testsite.com. 300 IN NS ns09.p.fasttide.net.

Step A6. Save the changes you made to your DNS zone file.
Step A7. Restart your DNS software to reload the DNS zone file. On UNIX systems, the

command will appear as follows: kill - HUP named

Section B. CONFIGURING YOUR SITE FOR A PRE-DEPLOYMENT TEST
Please complete the following steps to configure the acceleration of your Web server for testing
prior to production use:
Step B1. Copy the fasttide.gif file to your Web site's root directory.
Step B2. Copy your site's initial content page to the following file on your Web server (unless

this file already contains the initial content page): /homecontent.html

NOTE 1: For some sites, this will require you copy your default home page (for example,

index.html) to /homecontent.html. Please name this copied file the same name that you
entered into the “Initial Content Page” field when you created the policy. This page
must be in your Web site's root directory.

NOTE 2: Your Initial Content Page should not be set to “/” as this is the same as your default

page and will cause your site not to accelerate.

Section C. VERIFYING THE ACCELERATION POLICY IS OPERATIONAL
Step C1. Clear your browser's cache, then enter the following URL on your browser to verify the

acceleration policy is active: http://www.fasttide.net/www.testsite.com
If your acceleration policy is not active, you will receive a 404 Page Not Found error.
However, if your policy is active, you should receive your home page as defined in
Step B2 of the previous section Configuring a Site for a Pre-Deployment Test.

Step C2. Verify your site's initial content page, /homecontent.html, displays the proper content

and the links behave as expected. Be sure to test all links on your site by navigating the
links on your browser. Please remember links to other sites will not be accelerated.

Step C3. Copy the HTML redirection file to the following temporary file on your Web server:

/fasttide.html
If you are accelerating multiple domains, use this HTML redirection file for this site
(www.testsite.com) only.
This file is a temporary access page for testing the site with acceleration. Any requests
to the site through this page will be redirected to the FastTide Network Nodes and
accelerated. This will allow you to test the service before you move production traffic
through the system.

Step C4. Clear your browser's cache, then enter the following URL on your browser to verify the

Site default page is properly configured: http://www.testsite.com/fasttide.html
You should receive your site's home page as you viewed in Step C1.

Step C5. If your site uses cookies, verify cookies are properly handled. Please note that the

cookie's domain must conform to your primary domain name.

Step C6. Verify your site's home page is displaying the proper content and the links behave as

expected. Please repeat the tests described in Step C2.
YOU HAVE NOW COMPLETED THE STEPS FOR A PRE-DEPLOYMENT TEST

AND CAN BEGIN TESTING THE EFFECT THE FASTTIDE SERVICE HAS ON YOUR
SITE'S PERFORMANCE. PLEASE PROCEED TO SECTION D ONLY AFTER YOU HAVE
COMPLETED SECTIONS A, B AND C AND HAVE TESTED THE OPERATION OF THE
FASTTIDE SERVICE.
Section D. CONVERTING TO A PRODUCTION ENVIRONMENT

After completing Sections A, B and C, please perform the following steps to configure

the acceleration of your Web server for production use:
Step D1. Rename the temporary access page created in Step C3 from fasttide.html to your site's

default page: /index.html
A template has been provided in the HTML redirection file if you need to support
search engines. Be sure to modify the <Meta...> tags in the HTML redirection file if
you want to set the title or require keyword and description support for search engines.

Step D2. Clear your browser's cache, then enter the following URL on your browser to verify

your users can access your accelerated site when they navigate to your company's
domain name: http://www.testsite.com

Congratulations! You have completed all of the configuration steps to accelerate your site.
--Customer Support

------------------------------End Example 3 Email------------------------------

Thus, according to further embodiments of the present invention, a system according to the invention can enable customer control through a point and click web-based solution. Many current content acceleration solutions are cumbersome, time-consuming, and difficult to implement. Therefore a web host or publisher must be prepared well in advance for any traffic surges across the business web site. Once many prior acceleration services are “turned on”, every request for content from a web site results in a premium charged for that traffic.

Using the acceleration methods as taught herein according to specific embodiments of the present invention, an easy-to-use customer interface allows near-real time implementation of acceleration policies, which make it possible for a publisher or host to implement acceleration service only when traffic demands it. Acceleration service can be implemented regardless of the type of web site platform currently in use and can be configured entirely through simple web interfaces, with no special requirements for the end-user's browser.

Thus, according to specific embodiments, acceleration requires only a few simple steps to implement because files and content do not need to be reworked.

The steps are:

1. Customers may sign up for acceleration service online.

2. The service provides a few simple files (such as test files) for the customer to load on their site.

3. Through the web interface, customers activate the parameters for when and how they want to optimize their content in a “policy”.

When these steps are completed, an acceleration service according to the current invention begins site optimization. Generally, there are no ongoing maintenance requirements and after configuring service, customers only need to interact with the service when modifying policies or examining reports. In addition, customers have the option of delegating a subdomain to the service in order to further improve browser performance.

15. Aggregator Module

In specific example systems, an aggregator component processes data provided by a retargetter infrastructure (e.g. FastTide™) and Content Distribution Networks and inserts the processed data into a database system for use in reporting activities. According to specific embodiments of the invention, an Aggregator can reduce data from individual transactions into time increment aggregate totals to minimize transfer and storage requirements.

The Aggregator operates at retargetter notes (e.g. FastSites™) and at an Admin site. Retargetter Node (e.g FastSite™) aggregators move performance data generated by Retargetters and traffic data recorded by FastSite™ caches from the FastSite™ to the Admin site. Admin Aggregator retrieves data from Retargetter Node (FastSite™) Aggregators and retrieves detailed traffic reports from the Content Distribution Networks through FTP and/or e-mail delivery services, or other services provided by different Content Distribution Networks. Admin Aggregator then inserts this collection of data into the database system. As a result of this activity, the database system contains the data used in performance, traffic, and billing reports. System management services are provided to support real time monitoring, state management, and configuration control.

16. Reports

According to specific embodiments of the present invention, a system or method according to the invention further provides visibility into performance through sophisticated reporting. Some existing solutions to slow response times result in a lack of visibility into end-user behavior for the publisher. Caching technologies move the content closer to the end-user, which speeds up response times but eliminates the direct contact between the end-user and the publisher. To address this problem, a system according to specific embodiments of the present invention, includes a sophisticated reporting platform that gives Web hosting companies visibility into the quality of the viewing experience for their end-users. Customers/publishers can use this information to manage the effective deployment of content on Web servers to ensure maximum performance for each viewer.

In further embodiments, a reporting function provides publishers with the ability to receive reports based on the traffic created when accessing their site. In specific embodiments, controls may be provided for reports to allow a) reporting for the publisher as a whole or as individual sites; b) selection of time intervals, time zones, and data granularity; and c) selection of presentation and download options. Reports may include a tabular and/or graphic representation. According to specific embodiments of the invention, reports in one or more of the following categories can be provided: Performance, comparing the average performance of the origin site against the average performance of the selected acceleration network and possibly of the average of the non-selected networks. These reports may be derived from the browser-based response time collected when retrieving a test file; Bandwidth Usage reports present the traffic served through the acceleration infrastructure and include data collected from the acceleration network and Content Distribution Networks; URL Usage reports present site usage on a per URL basis; Billing Usage reports present the actual usage information to be used in billing.

System-wide reports may further be facilitated by capturing performance data at an aggregator interface at a retargetter node and then forwarding that performance data to an aggregator module at an admin site.

The data in the CDN log files is used to generate Traffic and TopURL reports. CDN log files contain an entry for every accelerated object served by the CDN and are retrieved by the AdminSite Aggregators.

A Reporting Interface provides publishers with the ability to generate reports based on the traffic created when accessing their site. Controls are provided for all reports to allow a) reporting for the publisher as a whole or individual sites; b) selection of time intervals, time zones, and data granularity; and c) selection of presentation and download options. All reports include a tabular and graphic representation. According to specific embodiments of the invention, the following categories of reports are provided:

1. Performance—These reports compare the average performance of the origin site against the average performance of the selected acceleration network and the average of the non-selected networks. These reports are derived from the browser-based response time collected when retrieving a test file, such as FastTide™.gif.

2. Bandwidth Usage—These reports present the traffic served through the acceleration infrastructure and include data collected from the acceleration network and Content Distribution Networks.

3. URL Usage—These reports present site usage on a per URL basis. URLs may be sorted based on bytes served or number of requests.

4. Billing Usage—These reports present the actual usage information to be used in billing.

Other service interfaces can be provided to administer other aspects of the system.

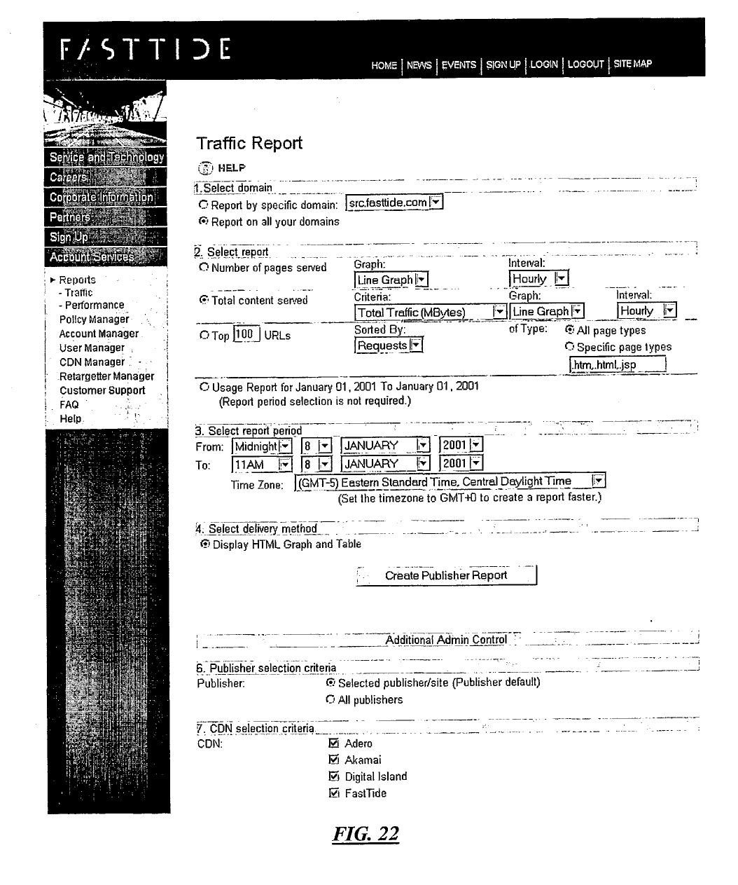

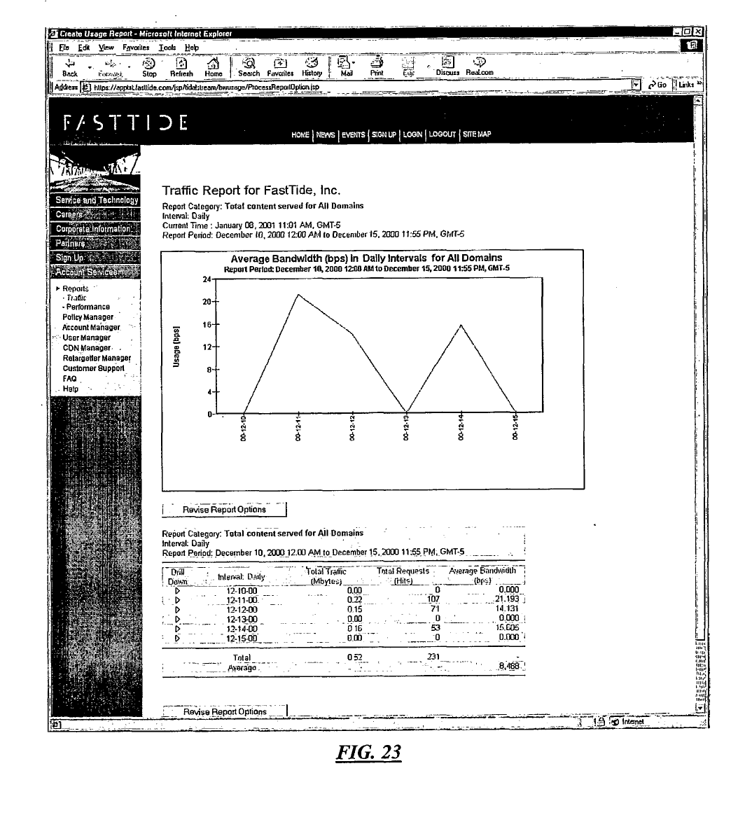

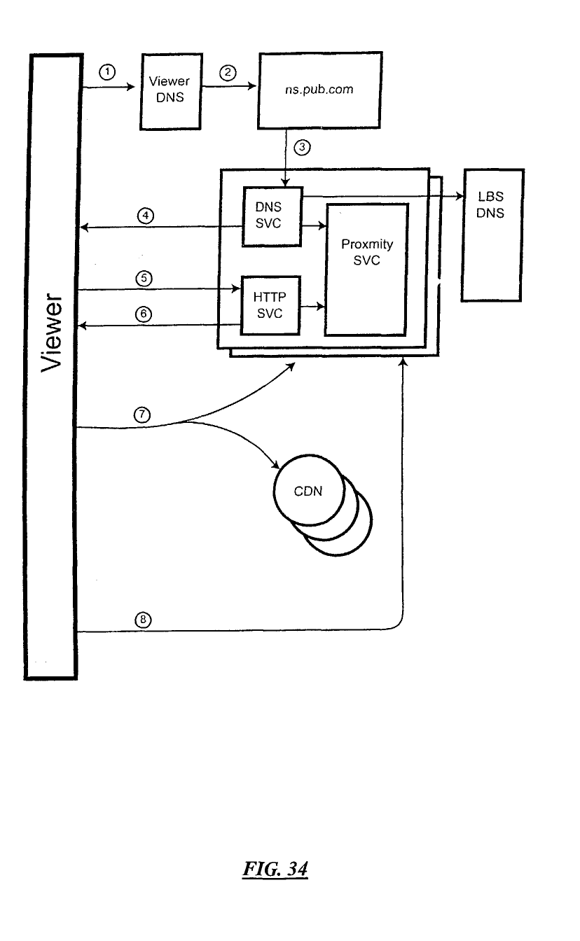

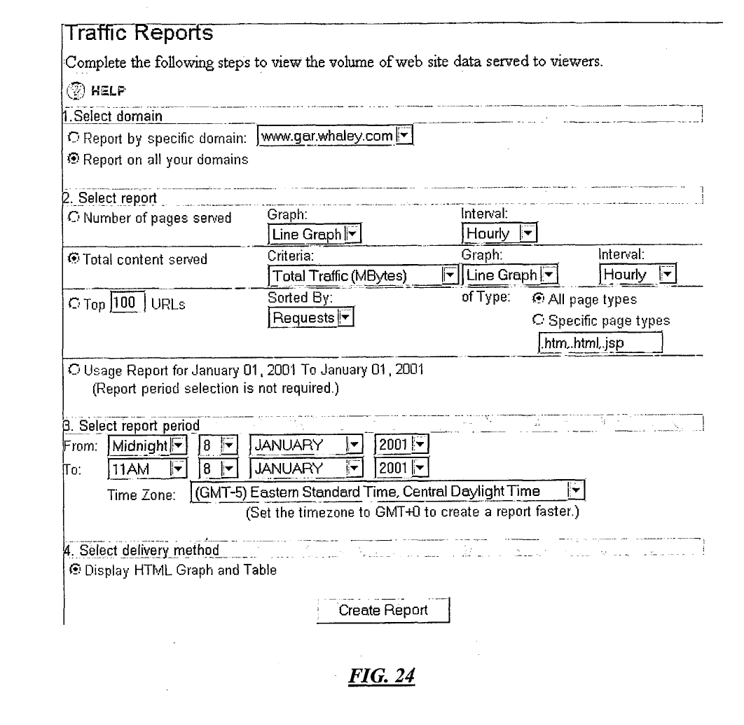

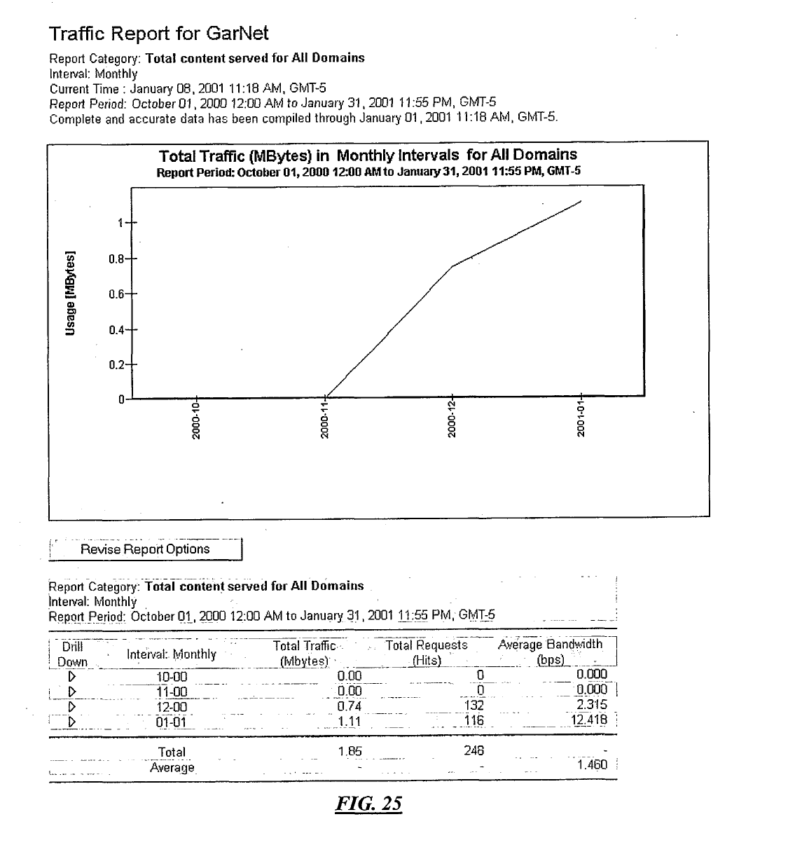

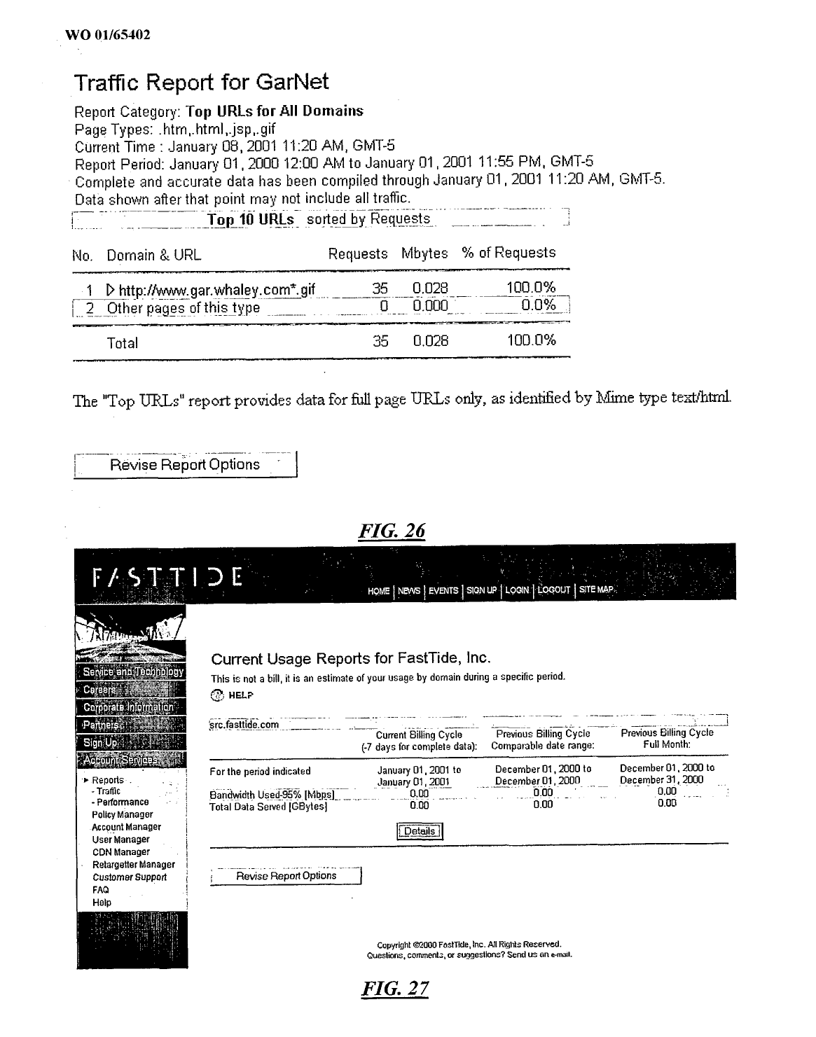

FIG. 22 through FIG. 27 illustrate, as examples, graphical user interfaces allowing for selection of traffic reporting and according to specific embodiments of the invention and for display of traffic statistics. These figures illustrate as examples the options discussed above. It will be understood to practitioners in the art from the teachings provided herein that a number of other arrangements and designs of the user interface are possible and within the scope of the invention. FIG. 22 is an illustration of an example graphical user interface for administration traffic menu selection allowing an authorized user to request a traffic report according to specific embodiments of the invention. FIG. 23 is an illustration of an example graphical display of an administration traffic report according to specific embodiments of the invention. FIG. 24 is an illustration of an example graphical user interface for traffic report option selection according to specific embodiments of the invention. FIG. 25 is an illustration of an example graphical display of a user traffic report over all domains according to specific embodiments of the invention. FIG. 26 is an illustration of an example graphical display of a user traffic report by URL according to specific embodiments of the invention. FIG. 27 is an illustration of an example graphical display of an estimated billing statement according to specific embodiments of the invention.

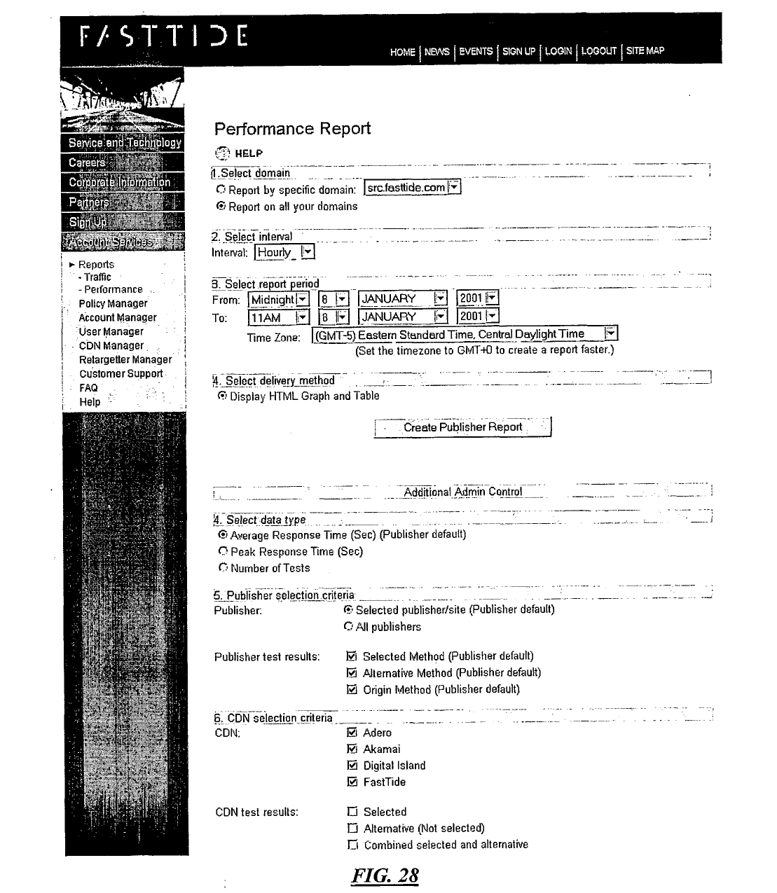

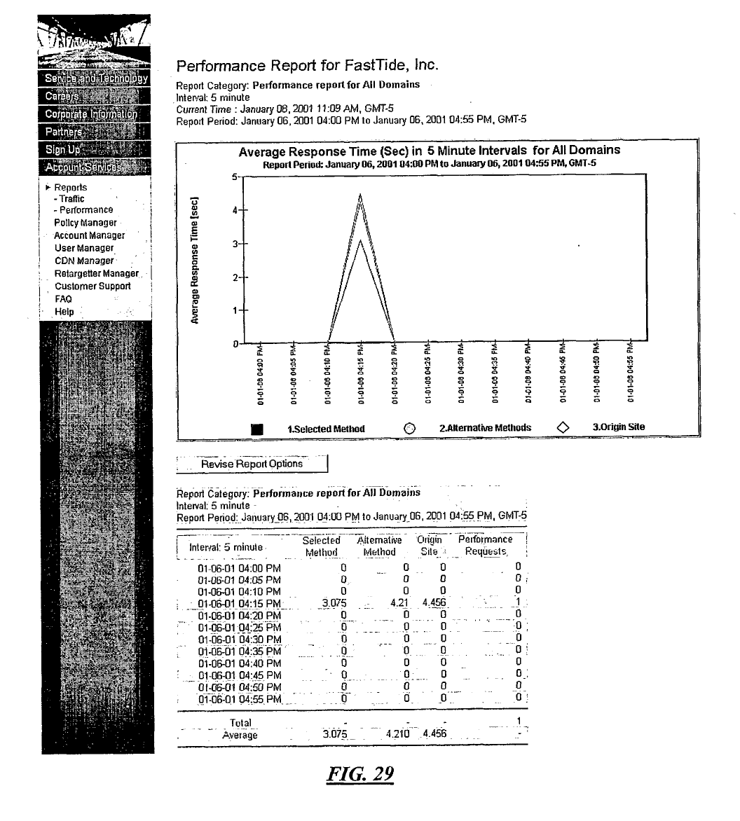

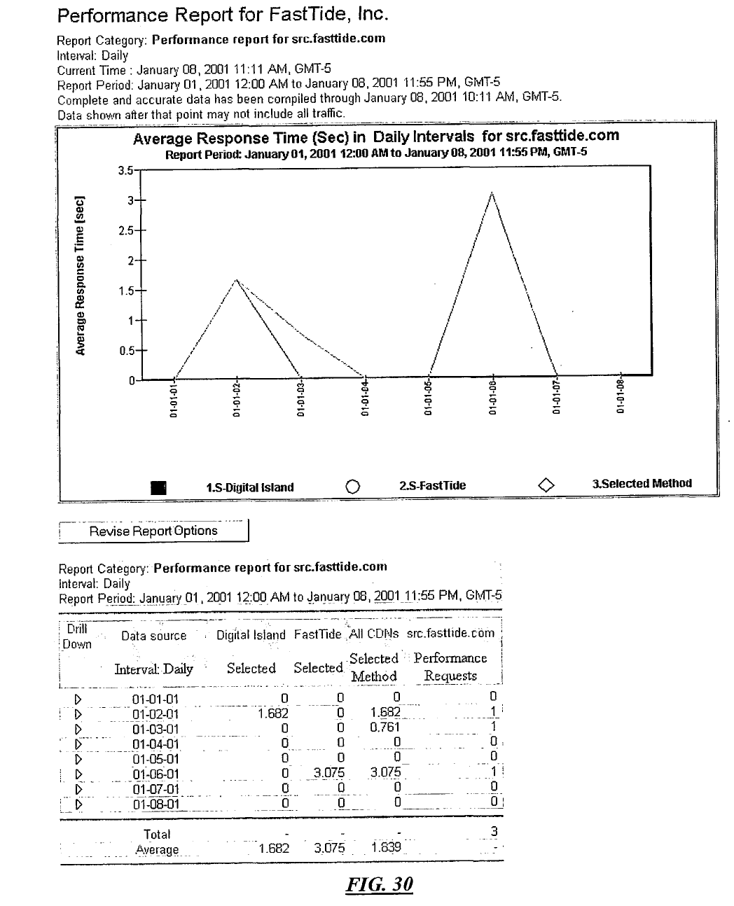

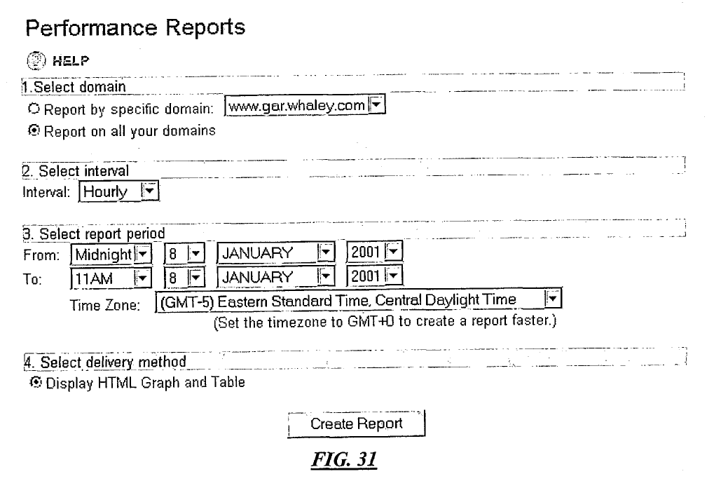

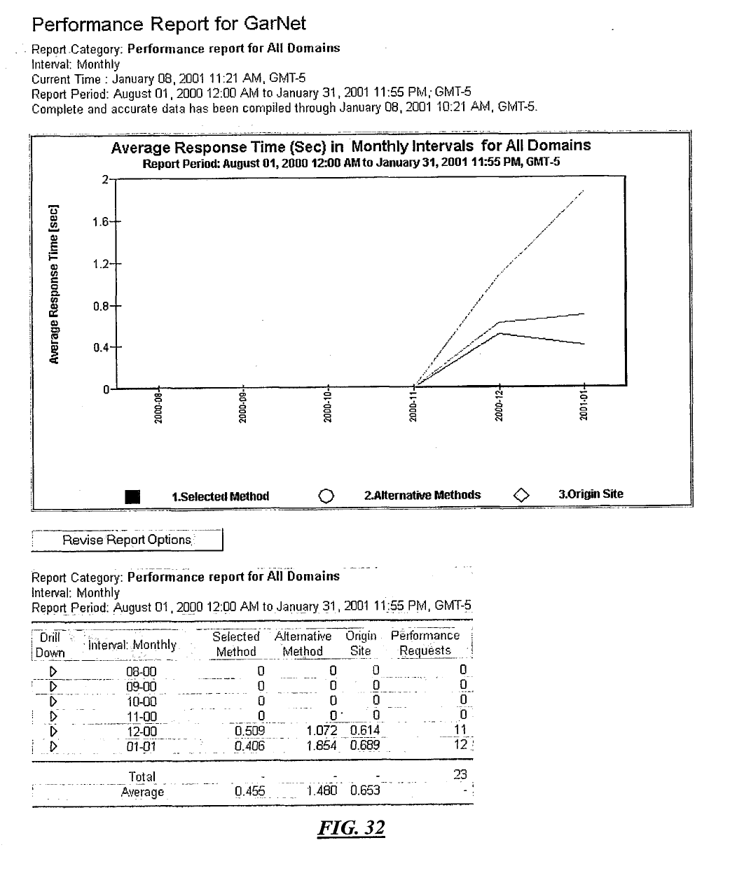

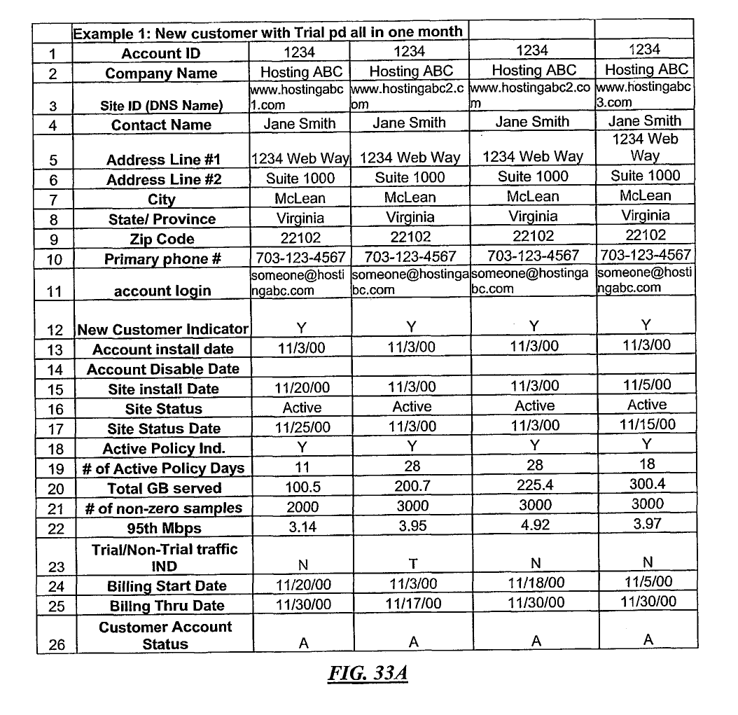

FIG. 28 through FIG. 32 illustrate, as examples, graphical user interfaces allowing for selection of traffic reporting and according to specific embodiments of the invention and for display of traffic statistics. These figures illustrate as examples the options discussed above. It will be understood to practitioners in the art from the teachings provided herein that a number of other arrangements and designs of the user interface are possible and within the scope of the invention. FIG. 28 is an illustration of an example graphical user interface for administration performance menu selection allowing an authorized user to request performance reporting according to specific embodiments of the invention. FIG. 29 is an illustration of an example graphical display of a retargetter acceleration report according to specific embodiments of the invention. FIG. 30 is an illustration of an example graphical display of a retargetter acceleration report according to specific embodiments of the invention. FIG. 31 is an illustration of an example graphical user interface for a user performance menu selection allowing an authorized user to request performance reporting according to specific embodiments of the invention. FIG. 32 is an illustration of an example graphical display of a user performance report according to specific embodiments of the invention.

17. Retargetter

The Retargetter 210 (or Retargetter Node 200) is the core component that interfaces with the viewer and from the browser's perspective appears to be the DNS server and web server. This component dynamically routes user requests to Content Distribution Networks. In specific example systems, the following services are provided by the Retargetter:

Performance Measurement

A performance measurement test can be performed on the viewer's browser. This measurement script measures the performance of each Content Distribution Network (and, according to specific embodiments of the invention, also of the acceleration system regions) and registers these times.

According to specific embodiments, a system can include a Retargetter Proximity Service 216, which is described in more detail below. With a Retargetter Proximity Service present, times are registered with the Retargetter Proximity Service 216. If the Proximity Service 216 contains no recent historical information for this viewer's IP block, the Performance Measurement process will result in the automatic selection and retrieval of content through the fastest Content Distribution Network and acceleration system region.

HTTP Service (URL Translation)

The HTTP service 214 converts the links to content served up from the origin site to links to the appropriate Content Distribution Network for non-URL containing content. Links to other web pages or to other URL containing content served from the origin site are directed through the FastTide™ network so that subsequent translation may be performed on those pages. In a specific example embodiment, the HTTP service supports the HTTP 1.1 protocol. This service translates HTML as follows: (1) Conversion of content links to the selected Content Distribution Network naming convention; (2) Generation of domain naming convention identifying the network and region used in the acceleration. The translation service can also provides full support of cookies and JavaScript defined content and links.

DNS Service

DNS Service 212 is provided to support dynamic creation and management of domain names. All Frame-based policy domain names are fully dynamic—existing only in the Retargetter DNS service. Subdomain-based policy names must be specified by the delegating authority. In each case, the domain naming scheme used is fully dynamic and managed through the DNS service. The DNS service validates all domain names using the policy definitions retrieved by the Policy Update Retrieval service.

Proximity Service

In further example systems, a proximity service 216 can be provided. When present, the proximity service tracks performance indicators for each Content Distribution Network (and possibly, in a further optional embodiment for different FastTide™ regions). These performance indicators are then used to support immediate selection of the fastest route for serving content on behalf of the user. An example Proximity Service can track these indicators based on the first portion of the IP address, referred to here as the IP block. This block of IP addresses represents a number of addresses that are typically located at the same physical geographic and network location.

Policy Service

This service identifies and validates web sites that the service is accelerating. This service maintains a mapping of the set of all active Publisher policies. This service periodically retrieves policy update information from the Admin service to ensure the Retargetter has the most current policy information. Retrievals typically occur every 5 minutes. Local persistence of policy information is performed to guarantee recovery in the event of Admin access failures.

System Management Service

This service is provided to support real time monitoring, state management, and configuration control.

18. Other Example System Components

According to specific embodiments, other system components may provide a role in the operation of acceleration services, as further described below:

1. Database 120—A Oracle or similar database system is used to house publisher profile, user profile, policy, bandwidth usage, and URL usage data maintained by the system.

2. Application Server—The WebLogic application server is used to implement the business logic and database access necessary to maintaining publisher profiles, user profiles, profiles, reports, etc.

3. Cache 220—Caches contain cacheable content include the objects served by Retargetters. The caches utilize the time-to-live attribute set on the objects as defined in the policy. Traffic reaching the cache is recorded and entered into the database by the Aggregator component.

4. Web Server—A WebLogic application server or similar module can be used to dynamically generate web pages based on the user request and business logic implemented by the Application Server.

19. Operations Center

According to further specific embodiments of the present invention, central operations center can assist in coordinating/controling a network of distributed nodes (e.g. retargetters) that in turn control the actual distribution of content. According to specific embodiments of the present invention, the chief purpose of each retargetters is not to distribute large quantities of content, but rather to support communications to the viewer's browser and intelligently direct the browser to the best content distribution point, which may be on the FastTide™ network itself or any one of several caching or acceleration networks. The FastTide operations center can monitor the full FastTide network 24 hours a day, 7 days a week, 365 days a year to maintain real-time information on the FastTide network distribution (retargetter) nodes and proactively monitor all of the caching and acceleration provider networks that FastTide uses. The architecture of the operation center and each distribution node is fully redundant with fail-over capability for both hardware and connectivity. All infrastructure is maintained in fully secure sites. Nodes consist of switches, firewalls, caches, and servers, which have been engineered to ensure rapid scalability as traffic expands. Finally, because the underlying technology design is based on choosing among multiple delivery alternatives, access to these alternative delivery methods builds an additional level of reliability into the network, which ensures there is no single point of failure.

19. Policy Analysis and Transmission to Retargetter Nodes

Implementing Policies Selected by Publishers

An Admin Module according to specific embodiments of the present invention, can also perform one or more of the following actions to support the retrieval of policy updates and distribution of updates to individual retargetters. Retargetters utilize policy information in order to implement the site specific controls specified by the policy. Policy updates encapsulate the policy information from the Admin Module that is distributed to the retargetters.

Generate Policy Updates

A scheduled process utilizes a system interface to initiate the creation of a baseline and delta policy update. A baseline policy update contains all active policies currently defined in the Admin system. A delta policy update contains the policies being added and removed since the last baseline. The generation process must identify active policies, expire policies for accounts that become disabled and for policies set to the Expiring state, and disable policies that have conflicts. Policy updates are defined using an XML data representation.

Regenerate Policy Updates

This system interface is available for on-demand (maintenance) operations to reconstruct the baseline policy update in the event a corruption to the policy update has occurred. An empty delta policy update is created with a flag indicating the forced creation of the baseline. This flag is used during the Retrieve Policy Updates process to ensure that only the baseline is retrieved.

Retrieve Policy Updates

This system interface provides the ability for remote Retargetters to retrieve the policy updates. The interface uses a version number to determine if there has been a change to the policy update held by the Retargetter. If so, either a new baseline or aggregate of delta policy updates will be returned. A hash code is also used to validate the internal integrity of the policy update construct.

The following interactions are performed among the Admin and Retargetter components in order to ensure policy updates are available for use in accelerating a site.

Generate Policy Update Process

A Policy Updates Scheduler, according to specific embodiments of the present invention, requests generation of policy updates. Then, at the Admin module:

i. Queries are performed to extract policies as follows:

a. Scheduled policies for approved accounts.

b. Expiring policies.

c. Active policies in which the publisher account is disabled or closed.

ii. Retrieved policies change state as follows:

a. Scheduled policies are changed to an active state if they meet criteria for activation, otherwise they are disabled.

b. Expiring policies change to the expire state in order to terminate acceleration.

c. Active policies in which the publisher account is disabled or closed change state to expired in order to terminate acceleration.

iii. Create delta and baseline policy updates using an XML structure.

a. The policy updates XML structure contains policy information for each active site organized by publisher. Policy updates may contain multiple publishers and multiple policies per publisher.

b. The delta policy update is updated to include all new or updated policies and to expressly indicate deleted policies as removed. The delta policy update reflects only those policies changed during this update activity.

c. The baseline is updated to contain all active policies at the time the delta policy update is generated.

iv. Persist delta and baseline policy updates in the database for later retrieval by retargetters.

v. Finally, the scheduler schedules the next policy generation event.

Retrieve Policy Update

For this process, a retargetter requests retrieval of policy updates and can also pass version and hash attributes. The version attribute is used as a token to determine the sequence of policy updates that occur over time. The latest delta and current baseline policy update always have the same version attribute. The hash attribute is used for internal data integrity validation.

Admin Handling of Requests for Update:

i. The version attribute is evaluated to synchronize the Retargetter's Policy Update with the delta and baseline policies stored in the database. The following steps are performed:

a. Determine if version is same as the baseline version. If the version is the same, no policy update is transmitted to the retargetter.

b. Determine if the version matches an existing delta version. If there is no corresponding delta version, then transmit the current baseline.

c. If there is a corresponding delta version, then retrieve all subsequent delta versions, aggregate them into a single policy update, and transmit this update to the Retargetter. The version of the delta reflects the current version value of the baseline.

d. If in the processing of the deltas, a delta is encountered indicating a forced creation, then the current baseline is transmitted. Forced creations occur if the baseline policy updates is reconstructed on demand not using the delta approach.

Retargetter Processing of Updates:

a. If no update is returned, nothing is done.

b. If a new baseline is returned, then the old policy update held by the retargetter is discarded and replaced by the new policy update.

c. If a delta is returned, then the old policy update is amended with the retrieved delta. The version and hash are updated based on the new delta version.

d. Translation tables are then reconstructed if a policy update is retrieved. At this point, any new request will utilize the new policy definitions held by the Retargetter.

e. The resulting XML policy update is persisted to disk for retrieval in the event a restart is required and the Admin site is unavailable to retrieve the current baseline.

f. If the Admin site cannot be reached, Retrieve the file-based XML Policy Update from disk.

g. If neither the admin site nor the file-based XML Policy Updates are available, then periodically retry. The service will not be available to process requests until an XML policy can be retrieved.

h. Finally, the Retargetter will schedule next policy retrieval event.

20. Billing and Pricing Methods

In a further embodiment, a variety of different pricing plans can be used to bill publishers for acceleration. Described below are a variety of example pricing plans according to specific embodiments of the present invention. Service is available under two different pricing methods depending on the customer's volume of traffic and pattern of use during a billing period. Customers that deliver more than 75 Gigabytes from their site in a month may choose Bandwidth Pricing, while smaller sites may choose Traffic Delivered Pricing.

Bandwidth Pricing

Bandwidth Pricing is based on bandwidth usage during a billing period—e.g. megabits per second used during a month. The usage measurement is derived from the content distributed from the source Web site through the retargetters, inclusive of all traffic types—HTML, GIF, JPEG, PDF, etc. Customers pay only for the amount of capacity used and only for the amount of usage distributed via retargetters. Any content distributed directly from the Web site is not included in billed usage. The methodology for calculating the customer's invoice is a “burst” methodology for measuring usage, common in the Web site hosting and Internet access industry. Details of this method are described below.

Traffic Delivered Pricing

Traffic Delivered Pricing is intended for smaller sites that don't have enough traffic to justify buying the minimum of 1 Mbps of capacity for use during a month required by the bandwidth model. These customers may opt for pricing based on traffic delivered, which bills a fixed rate for each Gigabyte of data delivered by FastTide.

This method simply accumulates the total data delivered by retargetters during the billing period for a particular domain and multiplies by a fixed rate, based on the customer's commitment.

Burst Rate Pricing Plan:

First, calculate the 95% usage level for EACH site, with samples used in calculation are non-zero samples for each specific site and the top 5% of samples are “thrown out” and not used in calculating the Mbps.

To determine which samples are “thrown out”: (1) Rank all non-zero samples taken during the month (or other designated period) from highest to lowest; (2) based on the total number of samples in the period, calculate the number of samples to be thrown out, i.e. if there are 5000 non-zero samples in a current billing month, the top 250 samples would be thrown out.

After the 5% samples are “thrown out”, the volume in the very next highest sample is deemed to be the customer (publisher) usage level for the month (in example above, the 251st sample would be used) for that specific site. Then calculate the Mbps for each site to include on bill and based on usage level calculated for each site, bill the customer based on whole Mbps increments for each site.

According to specific embodiments of the present invention, various rounding conventions can be used, for example: (1) Round up to next whole Mbps if the fractional Mbps usage is greater than 0.10 on a site by site basis (may not be rounded for publisher in aggregate); (2) round down to the next whole Mbps if the fractional Mbps usage is 0.10 or less.

Volume threshold pricing tiers may be established based on aggregate publisher volume ranges and a discount threshold can be adjusted for the contract term that the customer has selected (e.g. no term, 6 month term, or 12 month term). The following is an example of the threshold tiers for aggregate customer volume ranges: <<<the pricing included is illustrative only>>>

| Contract | | | | Over |
|---|---|---|---|---|
| Term | Up to 5 Mbps | 6-20 Mbps | 21-50 Mbps | 50 Mbps |
| No Term | $2,200 per | $1775 per | $1500 per | $1350 |
| | Mbps/mo. | Mbps/mo. | Mbps/mo. | Mbps/mo. |
| 6 mo Term | $1980 per | $1600 per | $1350 per | $1215 per |
| (10% disct) | Mbps/mo. | Mbps/mo. | Mbps/mo. | Mbps/mo. |
| 12 mo Term | $1760 per | $1420 per | $1200 per | $1080 per |
| (20% disct) | Mbps/mo. | Mbps/mo. | Mbps/mo. | Mbps/mo. |

Using this methodology, the rounded Mbps for each site can be aggregated to determine the pricing range the customer (publisher) qualifies for in the current billing period. The Mbps at the unit price will be shown on the bill at the site level. Each Mbps for the Customer (publisher) will have the same unit price in a given month. Generally, the volume used to determine the threshold for the current month is based on billed (rounded) volume.

Generally, a period Mbps charge is prorated if the site is not activated for the entire period, though generally this pro-ration does not apply to active site that is “turned off” for a period of time during the month and may not apply in the month where the site is disabled.

According to specific embodiments of the present invention, a minimum charge for customers may be based on a 1 Mbps usage level (unless a customer has a minimum volume commitment). Minimum charges will continue to be billed for sites whose overall customer status was approved for at least a portion of the month regardless of the state of the most recent policy for the site. For example if a site had an active policy that expired in the previous month and the site had no active policies in the current month, but the customer status is approved, the site would be subject to the minimum usage charge (even though the site had no traffic during the current billing month). These monthly charges will continue to be billed until the customer status is closed or disabled OR the customer contacts FT to indicate that the site will no longer be accelerated.

For customers with minimum volume commitments, it is assumed that the commitment will be based on the aggregate customer volume (as calculated above—i.e. sum the usage levels for each site for the publisher).

Gigabyte (GB) Served Pricing Plan:

First, calculate the GB served for each site to include on bill and bill the customer based on whole GB increments for each site. According to specific embodiments of the present invention, round up to next whole GB unless the fractional GB usage is less than 0.005. When rounding from bytes to Mbytes use 1000 and not 1024. Calculate the price per GB, with term discount pricing will be available on a site by site basis and will be applied as follows:

| No commitment | 6 Mo. Commitment | 12 Mo. Commitment |
|---|---|---|
| $22 per GB served | $20 per GB served | $18 per GB served |

The GB served and the appropriate unit price will be shown on the bill at the site level. Assuming that the customer has the same term commitment level for each site, the GB served for each site will have the same unit price for each month. Additional volume threshold pricing discounts will not generally be used with the GB served pricing plan. Minimum charge for all customers is based on a $100 per site, with pro-rating as described above.

While according to one embodiment, a billing period=calendar month for all customers, other billing periods may be allowed according to other embodiments. According to specific embodiments of the present invention, customers may change their pricing plans (from GB served to Mbps and vice versa) during the month, but the change will not be effective until the next full bill cycle/calendar month (for example if customer changed plan for one site on January 3, the change would be effective for all volume generated after February 1. This will ensure that customer does not have 2 pricing plans in effect in a single bill/calendar month.

According to specific embodiments of the present invention, despite the fact that a customer or publisher acceleration may be actually handled by a variety of different, independent CDN systems, as determined by a retargetter, a publisher using a system according to the invention will receive a simple invoice just for the total acceleration services provided via the retargetter functions. An example of such an invoice according to a particular pricing method is shown below:

SAMPLE INVOICE (Bandwidth pricing example)

| | |
|---|---|
| FastTide | |
| Bill To: | |
| Hosting ABC | |
| 111 Duke | Invoice #11-00-1565 |
| Suite | Invoice Date December 18, |
| New York, NY | Customer ID1565 |

| | | | |
|---|---|---|---|
| Minimum Volume Commitment | | 5 | $11,000.00 |
| | Shortfall | 2 | $4,400.00 |
| | Subtotal | | $11,000.00 |
| | Service Charge | | $0.00 |
| | Current Invoice | | $11,000.00 |
| | Previous Balance | | $11,000.00 |
| | Payment received | | $11,000.00 |
| | Current Balance | | $11,000.00 |

21. Example Customer Data Structure

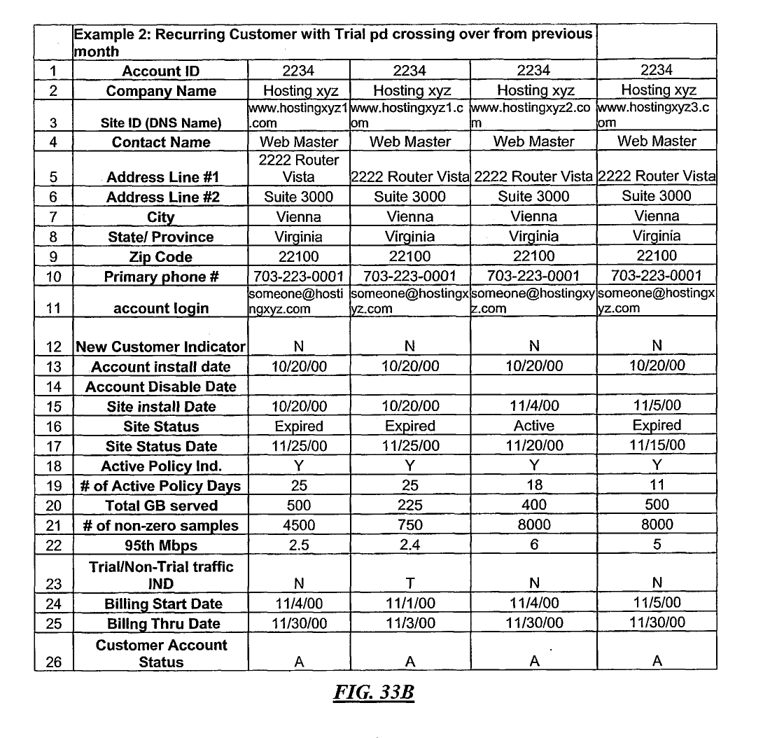

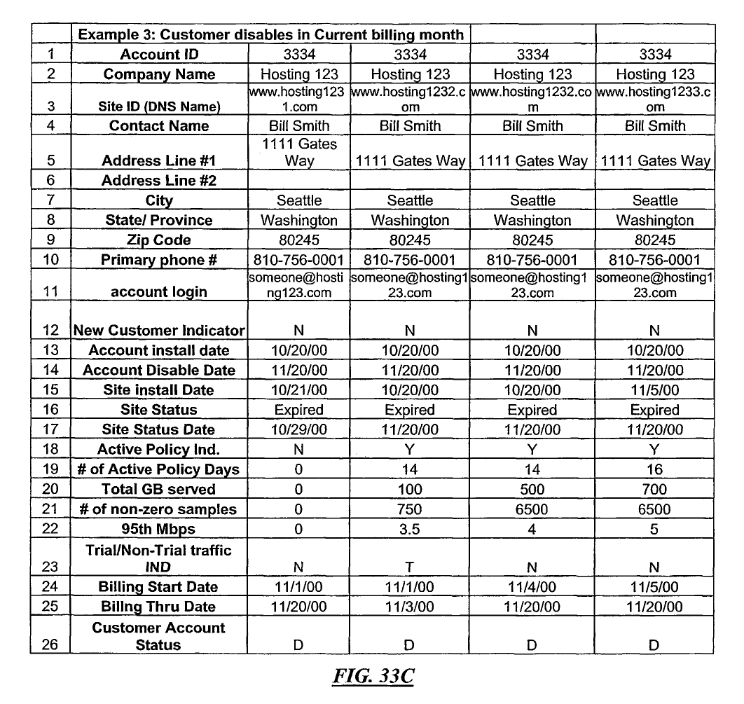

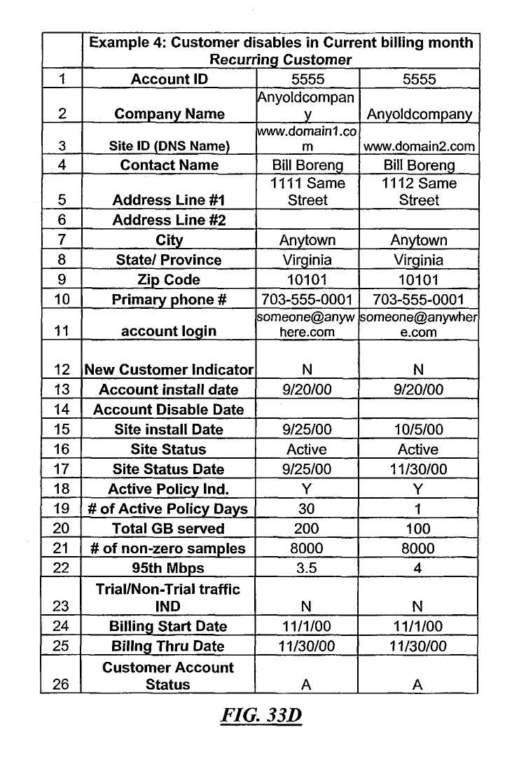

FIGS. 33A-D illustrate examples of customer database or data tables that may be used according to specific embodiments of the invention. In these examples, the following example data table (Table 7) is used at the ADMIN to manage policies and determine billing. It will be understood from the teachings herein that according to specific embodiments of the invention, not all of the data shown in the figures or in Table 7 will be maintained in all embodiments. Furthermore, other embodiments could include additional data fields or could group or specify data fields in different ways.

TABLE 7
EXAMPLE DATA TABLE

| Fld | Field Name | Definition |
|---|---|---|
| 1 | Account ID | 4 Digit Account ID in Database. |
| 2 | Company Name | Name of Company in Database. |
| 3 | Site ID (DNS | DNS Name for the site - only show sies that have had at least one active |
| | name) | policy on or before the last day of the billing month. |
| 4 | Contact Name | Point of Contact collected in Database from on-line form. |
| 5 | Address #1 | Address#1 collected in Database from on-line form. |
| 6 | Address #2 | Address#2 collected in Database from on-line form. |
| 7 | City | City collected in Database from on-line form. |
| 8 | State/Province | State/Province collected in Database from on-line form. |
| 9 | Zip Code | Zip code collected in Database from on-line form. |
| 10 | Primary Phone # | Primary Phone# collected in Database from on-line form. |
| 11 | accountlogin | As collected from on-line form (may be updated with different email for |
| | | billing contact in billing system). |
| 12 | New Customer | If customer account approved in current billing period then = “Y” |
| | Indicator | otherwise “N”. |
| 13 | Account Install | Date the account is set to “approved” (Note: If customer account is |
| | Date | disabled and then reapproved will still keep the previous approval date). |
| 14 | Account Disable/ | Date the account is set to “disable” or “close” if within the current billing |
| | Close Date | month, otherwise null. |
| 15 | Site Install Date | Release 1.3.1 - date that the 1st policy became Active on that site (repeat |
| | | for all sites). |
| 16 | Site Status | The status of the most recent active, expired or expiring policy as of the |
| | | last day of the billing month. |
| 17 | Site Status Date | The date associated with the policy status that is determining the site |
| | | status. |
| 18 | Active Policy | If a site had at least one active policy in the billing month then = Y |
| | Indicator | otherwise N |
| 19 | # of Active policy | The # of days in the billing month where there was an active policy on |
| | days | the site |
| 20 | Total GB served | GB served for Trial and non-trial traffic - round to the nearest 1/1000 GB. |
| | | Convert byte to Megabyte using the formula byte/10e6 (residual traffic |
| | | needs to be excluded after disable date as this is not billable) |
| 21 | # of samples | Total # of samples taken in the current billing period separatly stated for |
| | | trial and non-trial traffic. Will be based on non-zero samples only |
| 22 | 95th Mbps | Calculate 95th Mbps usage for samples on the trial and non-trial period |
| | | separately. Round to the nearest 1/100 h Mbps. Calculate 95th% mbps |
| | | usage on non-zero samples |
| 23 | Trial/Non-Trial | Indicates whether this is trial traffic or non-trial traffic. |
| | Traffic Ind. | Indicate N for non-trialand T for trial. |
| 24 | Billing Start Date | If the traffic is labeled as “T” the start date will be the greater of the 1st |
| | | day of the billing month or the site install date. If the traffic for the site is |
| | | labeled as “N and the site is the trial site then the start date will be the |
| | | greater of the (account approved date + 15) or the site install date or the |
| | | 1st day of the billing month. If the traffic for the site is labeled as N and |
| | | the site is NOT the trial site then the start date will be the greater of the |
| | | site install date or the 1st day of the billing month. |
| 25 | Bill-thru Date | If the traffic is labeled as “T” the thru date will be the earlier of either the |
| | | last day of the billing month or the (account approved date + 14). If the |
| | | traffic is labeled as “N” the thru date will be the last day of the billing |
| | | month, unless the account status set to Disabled of Closed, then the |
| | | Account Disable/Close Date should be used. |
| 26 | Customer | Customer Account Status as of the date the Batch is Run |
| | Account Status | |

22. Regional Based (Proximity) Selection

According to further embodiments of the present invention, a further process can be used to select the retargetter node (RTGNs) that will be servicing a particular viewer. For retargefter selection, a system according to the present invention is provided with or has more information about the retargetters location in a network topology and can therefore make a selection based on a retargetter's regional location or network location with respect to a particular viewer, and/or publisher. In contrast, according to specific embodiments of the present invention, CDN selection is abstracted by assuming that CDNs are globally available services and therefore CDNs are selected as elsewhere herein described (e.g. by a retrieving a test file and measuring at an end-system).

According to further embodiments of the present invention, intelligent content distribution is provided by employing both types of content source selection: straight-forward performance measures for CDNs and regional-based selection for RTGNs.

FIG. 34 is a block diagram showing steps in performing proximity cache service selection according to specific embodiments of the invention.

Implementing Regional Based CDN RTG Selection:

Furthermore, there are a number of additional features/options according to further specific embodiments of this aspect of the present invention that can be used to modify or enhance regional selection as described above.

Option I—Real-Time Selection with Weighted rtg_cdn_region_default

RTG sends the measurement code to the browser to pick the page based on the shortest responding time and provides a default based on region wide CDN weighted averages, which is computed using rtg_sample_percent=0.004 (e−1 or 37% response time of 250 measurements).

Option II—Weighted IP+CDN selection+Backup Real-Time Selection with Weighted CDN RTG Default

Select the IP region default as the default when there is sufficient data. In further embodiments, if the IP region data is recent, the currently performed viewer measurements will not be used to make selection for that viewer. Further, if regional data is present, but less recent or otherwise less trustworthy, the system can reduce (for example to one second) the amount of time the viewer has to make a decision based on a current measurement. If there is no valid information for IP region, the system can use retargetter wide defaults though allow the viewer to change that decision within a period (e.g. two seconds.)

RTG maintains an IP-CDN-Region Table. The IPs are grouped into 2K blocks, the 21 MSBs of the IP address are used to access records using a two level array of objects. The first level (ip1_cnd_region_table) is indexed by to top (config=16) MSBs and is only used to hold objects of the second level table. The second level (ip2_cdn_region_table) is indexed by the next (config=5) bits. A record in the second level table consists of: winning_CDN:“num”:byte; winning_region: “letter”:byte;sample_count:num:shortint; last_test_time:date; cdn_ave_delay(num_cdns):ms:shortint; region_ave_delay(num_regions):ms:shortint. These tables are periodically saved as files locally with the ip2_cdn_region_tables being stored in 64 separate files. These files can be read in upon startup. The weighted averages are computed using configurable ip2_sample_percent=0.1 (e−1 response of 10). A configurable recent sample timeout is also specified ip2_timeout=4200 s. The test count is updated as follows: if (sample_count<4/ip2_sample_percent) then sample_count++; The sample_count provides a measure of how valid the current numbers are and may be used to enhance the decision making criteria in the future.

If the RTGDNS receives a request for data, it uses the IP address table to provide RTG addresses from the region closest to the IP address. If the IPs table entry is null, it just provides the addresses from the arrowpoint as in Option I.

When the RTG receives the request for data:

1. If the ip2_cdn_region_table has any samples in it then:

IF (current_time-last_test_time<ip2_timeout)

send a CDN/region measurement script with a default redirect time of 0 seconds;

ELSE

send a CDN/region measurement script with a default redirect time of a configurable number of (e.g. 1) seconds;

IF (sample_count>0) then sample_count—;

2. If there is no data the ip2_cdn_region_table, then the rtg_cdn_region_default values are used to define the default redirection page with a redirect timeout of a configurable number of (e.g. 2) seconds. In this case the performance measurement page is used to perform the CDN/region selection and the collected sample should be fed back to the aggregators. The performance tests returned to the rtg are only incorporated into the rtg_cdn_region_defaults if it was the winning region.

The results of performance measurements should be sent back to each retargetter region.

Performance measurements containing ANY values<(config=25 ms) are not incorporated into the running averages because the probably reflect some browser cached data. In order to avoid anomalous results due to missing test (e.g. fasttide.gif) files at the tested source, any performance results containing the following conditions are also not used: the origin site>=timeout and at least two CDNs (including fasttide) are >=timeout.

The retargetter keeps the total number of performance measurements, the total number of high invalid reports, the total number of low invalid reports, and the total number of unaccelerated hits from unsupported browsers.

TABLE 8
SUMMARY OF IP CDN REGION TABLES

| Parameter | rtg_default | ip1_table | ip2_table |
|---|---|---|---|
| Size (bits) | 0 | 16 | 5 |
| Entries | 1 | 64K | 32 |
| sample_percent | 0.004 | NA | 0.1 |
| Enough Samples? | 250 | NA | 10 |
| (1/samples_percent) | | | |
| Files | 1 | NA | 64 |
| redirect timeout | 2 | NA | 0 |
| reported values | instant | NA | table |
| | measurement | | entry |
| HTML page timeout | not cacheable | NA | not cacheable |
| (min) | | | |
| Ignore records with | 25 | 25 | 25 |
| times < (s) | | | |

Option III

RTGs share the performance data with each other. Purpose: to accelerate the best CDN decision making process:

Benefits:

Higher performance.

More accurate CDN selection.

Consistent URL redirection (improves chances of using viewer caches).

Three Types of Performance Records:

fasttidereserved001 (ftr1)—from the viewer to one ProximityService.

fasttidereserved002 (ftr2)—from the ProximityService in one region to the proximity services in other regions, the format is like ftr1 but adds a source_ip field.

fasttidereserved003 (ftr3)—from the ProximityService that detects a change in the winning CDN or Region to other proximity servers in that region, the format is the same as ftr2.

TABLE 9
EXAMPLE ACTIONS TAKE BY THE PROXIMITY SERVICE

| | Average* | Update | CDN/Region | |
|---|---|---|---|---|
| In | (levels) | Time | Change | Out |
| ftr1 | yes(0,2) | yes | no | ftr2 - send a copy to all the regions. |
| ftr1 | yes(0,2) | yes | yes | ftr2 - send a copy to all regions. |
| | | | | ftr3 - send a copy to all local retargetters also. |
| ftr2 | yes(0,2) | yes | no | No further action. |
| ftr2 | yes(0,2) | yes | yes | ftr3 - send a copy to all local retargetters. |
| ftr3 | yes(0,2) | yes | Not Applicable | No further action. |

*Note: if the entry received is the first entry for the block, the entry should be used as the average without averaging it in to a zero value. All averages should be averaged into the ip2_table using the ip2_table sample_percent value. If the CDN/region changed or sample count is law, then send out a message. With this in place, versus sending out the information to all, there has been measured about 99.9% accurate.

According to specific embodiments of the present invention, test results transmission can be understood as follows: Viewer sends out 20 requests for cache sources, timer for each, gets 20 results back, sends each of these results on to one proximity service in the winning region.

Option IV

RTGs perform inline measurements that are embedded within the HTML page and results are returned within that page as opposed to within a window outside that page. This allows easier measurement on any page as opposed to just the first page.

23. Embodiment in a Programmed Information Appliance

FIG. 13 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 13 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

24. Other Embodiments

The invention has now been described with reference to specific embodiments. Other embodiments will be apparent to those of skill in the art. In particular, a viewer digital information appliance has generally been illustrated as a personal computer. However, the digital computing device is meant to be any information appliance for interacting with a remote data application, and could include such devices as a digitally enabled television, cell phone, personal digital assistant, etc.

In addition, channels have been described primarily as traditional network connections, with the appropriate corresponding hardware. However, channels are meant to be any channels capable of carrying data, including wireless channels, optical channels, and electrical channels.

It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein are incorporated by reference in their entirety for all purposes.

What is claimed:

1. A method for providing content distribution services to a publisher, comprising:
securing arrangements with two or more independent content distribution networks, each having multiple independent distribution sources;
for a request for a publisher's content, measuring performance for at least two sources, said at least two sources not necessarily managed by the same content distribution network;
selecting a distribution source for said publisher's content; and
redirecting a content request user to said distribution source.

2. A method according to claim 1 further comprising:
receiving payment requests from multiple selected content distribution network;
paying said multiple content distribution networks; and
providing a single bill to a publisher for content distribution services.

3. A method for providing content distribution services to a publisher, comprising:
securing arrangements with two or more independent content distribution networks, each having multiple independent distribution sources;
for a request for a publisher's content, selecting a distribution source for said publisher's content from at least two sources, said at least two sources not necessarily managed by the same content distribution network; and
redirecting a content request user to said distribution source.

4. A method according to claim 3 further comprising:
receiving payment requests from multiple selected content distribution network;
paying said multiple content distribution networks; and
providing a single bill to a publisher for content distribution services.

5. A method allowing publishers greater flexibility in utilizing CDN services comprising:
acting as a single source to publishers for managing acceleration policies, content distribution, and contract and payment arrangements; and
acting as the interface to one or more various independent CDN service providers.

6. A method of providing content distribution services to a publisher and charging for content distribution services comprising:
arranging with two or more independent content distribution networks to provide content distribution services to a retargetter infrastructure computer system;
for a request for said publisher's content, selecting a content distribution source for said publisher's content from sources including said two or more independent content distribution networks;
at said retargetter infrastructure computer system, redirecting a content request to a selected content distribution source; and
at said retargetter infrastructure computer system, tracking usage of content distribution sources to provide a single bill to said publisher for content distribution services from multiple selected content distribution networks.

7. The method according to claim 6 further comprising:
at said retargetter infrastructure computer system, fetching publisher content and providing fetched publisher content to a selected content distribution source.

8. The method according to claim 6 further comprising:
including said retargetter infrastructure computer system as one of possibly selected sources for content distribution.

9. A method of providing content distribution services in a network to a publisher of digitally encoded content comprising:
establishing arrangements with two or more independent content distribution networks to provide distribution services to an intermediate system;
for a request for a publisher's content, using a computer to select a distribution source for said request;
at said intermediate system, fetching publisher content; providing publisher content to said selected distribution source over a network;
redirecting a content request over a network to said selected distribution source; and
tracking and storing usage of selected distribution sources at said intermediate system in order to bill publishers for content distribution services.

10. The method according to claim 9 wherein said publisher is one of two or more independent publishers to which services are provided.

11. The method according to claim 9 wherein said selected distribution source can be one of said independent content distribution networks or an intermediate device.

12. A method of providing content distribution services to a publisher over a communication channel from a retargetter system, comprising:
establishing service agreements between said retargetter system and two or more independent content distribution networks;
for a request for a publisher's content received over a network, selecting a distribution source for said publisher's content from said independent content distribution networks or from said retargetter;
providing publisher content to said selected distribution source over a communication channel; and
redirecting a content request over a network to said distribution source; and
tracking and storing usage of selected distribution sources at said intermediate system in order to bill publishers for content distribution services.

13. The method according to claim 12 wherein:
said two or more independent content distribution networks interact with said retargetter system as though said retargetter system were a single publisher to which said independent content distribution networks were providing services.

14. The method according to claim 12 wherein:
said publisher interacts with said retargetter system as though said retargetter system were a single content distribution network providing services to said publisher.

15. The method according to claim 12 further comprising:
from said retargetter system, updating said distribution sources with updated publisher's content.

16. The method according to claim 12 further comprising:
at said retargetter system, allowing a publisher to reserve content distribution in advance for special events or promotions.

17. The method according to claim 12 further comprising:
at said retargetter system automatically rerouting publisher content and requests to another content distribution network if a selected content distribution network becomes unavailable.

18. The method according to claim 12 wherein said retargetter system comprises one or more retargetter nodes.

19. The method according to claim 9 further comprising:
receiving payment requests from multiple content distribution networks for providing distribution services to one or more retargetters;
paying said payment requests for distributing content from retargetters; and
billing publishers for content distribution services provided through or managed by said retargetters.

20. The method according to claim 12 further comprising:
receiving payment requests from multiple content distribution networks for providing distribution services to one or more retargetters;
paying said payment requests for distributing content from retargetters; and
billing publishers for content distribution services provided through or managed by said retargetters.

21. The method according to claim 12 further comprising:
using an accounting computer system to track and pay payment requests from multiple content distribution networks for providing distribution services to one or more retargetters;
using said computer system to track and bill publishers for content distribution services provided through or managed by said retargetters.

22. The method according to claim 21 further comprising:
for a particular publisher, using said accounting computer system to track acceleration services provided by different independent content distribution networks and differing charges of said different independent content distribution networks;
using said accounting computer system to provide an aggregate billing to a publisher based on differing charges of said different independent content distribution networks.

23. The method according to claim 21 further comprising:
for a particular publisher, using said accounting computer system to track acceleration services provided by retargetters to provide a bill to a publisher based on retargetter services provided and without regard for different charges of said different independent content distribution networks.

24. A method of calculating charges for content distribution services comprising:
using one or more retargetter nodes as intermediate delivery nodes to deliver publisher content to viewers, wherein delivered publisher content contains translated resource locators indicating selected content distribution networks for embedded content;
forwarding data regarding selected content distribution networks from said one or more retargetter nodes to an aggregator system;
forwarding data regarding serviced publisher content to said aggregator system;
at said aggregator system, determining appropriate aggregate charges for content distribution services to a publisher, where said appropriate charges include charges for utilization of services of various independent content distribution networks;
at said aggregator system, determining appropriate aggregate payments for content distribution services to a content distribution network, where said appropriate payments include payments for services provided to various independent publishers.

25. A data processing system for managing a services configuration for content distribution services comprising:
(a) computer processor means for processing data;
(b) storage means for storing data on a storage medium;
(c) first means for recording information about CDN usage of different CDN networks by one or more retargetters;
(d) second means for processing data regarding usage of acceleration services by one or more publishers and for determining charges to said publishers; and
(e) third means for processing data regarding aggregate CDN usage for an appropriate period to determine payments owed to CDNs.

26. A data processing system as claimed in claim 25, wherein said first means further comprises:
(a) means for receiving CDN usage data from a plurality of retargetters and storing on the storage medium;
(b) means for receiving publisher acceleration service data and storing on the storage medium;
(c) means for storing on the storage medium CDN pricing policies for a plurality of CDN services; and
(d) means for creating locations on the storage medium for storing data regarding:
(i) usage of a particular CDN's acceleration services and costs for said usage;
(ii) servicing of request for publisher content and acceleration provided.

27. A fixed media containing logical instructions that when loaded into an appropriately configured digital apparatus causes the apparatus to operate in accordance with the method of claim 9.

28. A method of content delivery over a network comprising:
establishing a two-tiered content distribution system, comprising:
first tier computer communication modules for providing distributed content to viewers from two or more independent publishers said first tier able to dynamically translate resource locators;
second tier computer communication modules for providing embedded distributed content to said viewers, said embedded distributed content accessed by said viewers via resource locators dynamically translated by said first tier. said first tier modules in communication with an accounting computer system for tracking and aggregating accounting charges for content delivery acceleration provided by said first tier and said second tier.

29. The method according to claim 28 further wherein said second tier receives embedded publisher content from said first tier systems and said first tier systems request embedded content from original publishers to provide to said second tier systems.

30. The method according to claim 28 further wherein said second tier comprises one or more independent content distribution networks, each said independent content distribution network providing services to said first tier modules as though said modules comprised a single publisher site and each said independent content distribution network billing said first tier for services as though said first tier comprised a single publisher site.

31. The method according to claim 28 further wherein said second tier comprises one or more independent content distribution networks, which may operate according to different resource locator mapping techniques and wherein said first tier modules dynamically translate resource locators to a format appropriate to a particular selected content distibution network before transmitting to a viewer.

32. The method according to claim 28 further wherein a module in said first tier may at times translate resource locators so that said module can at times act as a proxy second tier module for some viewers.

33. The method according to claim 28 further wherein said viewers communicate with said first tier modules and said second tier modules over a public, open protocol communications media.

34. The method according to claim 28 further wherein said viewers comprise general purpose browser modules for accessing a variety of network content in a standard network protocol.

35. The method according to claim 28 further wherein said second tier modules comprise independent content distribution networks that provide services to a variety of publishers on a public communications network.

36. A method allowing publishers to manage accelerated content delivery comprising:
providing a policy application to implement acceleration policies at a computing site not managed by a publisher;
providing an interface allowing a publisher, using a standard remote interface, to initiate or modify acceleration policies for the publisher's content; and
implementing acceleration policies for a publisher's content.

37. A method of providing content distribution services in a network to a publisher of digitally encoded content comprising:
establishing arrangements with two or more independent content distribution networks to provide distribution services;
for a request for a publisher's content, using a computer to select a distribution source for said request;
providing publisher content to said selected distribution source; and
redirecting a content request to said selected distribution source.

38. The method according to claim 37 wherein said publisher is one of two or more independent publishers to which services are provided.

39. The method according to claim 37 wherein said redirecting is accomplished by dynamically translating resource locators in a page prior to transmission to a viewer.

40. The method according to claim 37 wherein said selected distribution source can be one of said independent content distribution networks or an intermediate device.

41. The method according to claim 37 wherein: publisher content is provided to a selected distribution source from an intermediate source upon request from a selected distribution source.

42. The method according to claim 37 further comprising:
translating publisher acceleration policies to a selected distribution source, wherein different distribution sources may have different policy interfaces.

43. The method according to claim 37 further comprising:
if a content distribution network becomes unavailable, automatically rerouting publisher content and requests to another content distribution network.

44. The method according to claim 37 wherein said selecting comprises:
providing a viewer computer a list of candidate distribution sources; and
accepting from a viewer computer an indicator of a selected distribution source.

45. The method according to claim 44 wherein said selecting further comprises:
providing a viewer computer executable code allowing said viewer computer to measure response times to one or more distribution sources.

46. The method according to claim 37 wherein providing publisher content to said selected distribution source is accomplished by an intermediate retargetter system.

47. The method according to claim 39 wherein said translating is performed by an intermediate retargetter system.

48. A method of providing content distribution services to a publisher over a communication channel from a retargetter system, comprising:
establishing service agreements between said retargetter system and two or more independent content distribution networks;
for a request for a publisher's content received over a network, selecting a distribution source for said publisher's content from said independent content distribution networks or from said retargetter;
providing publisher content to said selected distribution source over a communication channel; and
redirecting a content request over a network to said distribution source.

49. The method according to claim 48 wherein:
said two or more independent content distribution networks interact with said retargetter system as though said retargetter system were a single publisher to which said independent content distribution networks were providing services.

50. The method according to claim 48 wherein:
said publisher interacts with said retargetter system as though said retargetter system were a single content distribution network providing services to said publisher.

51. The method according to claim 48 further comprising:
from said retargetter system, updating said distribution sources with updated publisher's content.

52. The method according to claim 48 further comprising:
from said retargetter system, translating publisher acceleration policies to said distribution sources, wherein different distribution sources may have different policy interfaces.

53. The method according to claim 48 further comprising:
at said retargetter system, allowing a publisher to reserve content distribution in advance for special events or promotions.

54. The method according to claim 48 further comprising:
at said retargetter system automatically rerouting publisher content and requests to another content distribution network if a selected content distribution network becomes unavailable.

55. The method according to claim 48 wherein said retargetter system comprises one or more retargetter nodes.

56. A method of providing content to a viewer comprising:
performing an initial redirection to a retargetter system, said retargetter system thereafter being the source to a viewer of content containing resource locators;
performing second redirections at said retargetter system to one or more cache sources, said cache sources thereby becoming the source to a viewer of embedded content.

57. The method according to claim 56 wherein said second redirections can indicate sources in two or more independently managed content distribution networks.

58. The method according to claim 56 wherein said second redirections can indicate sources in two or more independently managed content distribution networks and wherein said second redirections can be formatted to comply with different redirection schemes of said two or more independently managed content distribution networks.

59. The method according to claim 56 wherein said initial redirection is performed at a publisher website in response to an initial viewer request to access publisher content.

60. The method according to claim 56 wherein said initial redirection is selected from the group consisting of:
resetting a domain name for said publisher to said retargetter node; and
performing a frame redirection at said publisher site to said retargetter system.

61. The method according to claim 56 wherein said second redirection is accomplished by dynamically modifying embedded content locators in said content to indicate said cache sources.

62. The method according to claim 61 wherein said dynamically modifying locators can be modified for particular cache sources in accordance with either directory-based content distribution file mapping or DNS-based content distribution file mapping, as appropriate for a particular cache source.

63. The method according to claim 56 further comprising:
at said retargetter system, providing candidate cache sources to a client and instructions for said client to measure response times to said cache sources; and
at said retargetter system, receiving data indications from a viewer indicating results of response time measurements.

64. The method according to claim 63 wherein said results indicate a cache source selected at a viewer system.

65. The method according to claim 63 wherein said candidate cache sources comprise at least two independently managed cache sources.

66. The method according to claim 63 wherein said candidate cache sources comprise at least two independently managed cache sources having at least two different file mapping protocols.

67. The method according to claim 63 wherein said candidate cache sources comprise at least one independently managed cache source and said retargetter system acting as a cache source.

68. The method according to claim 63 wherein said instructions comprise an indication to execute measurement code present on said viewer.

69. The method according to claim 63 wherein said instructions comprise executable code for measuring response times at said viewer.

70. The method according to claim 80 wherein said measuring performance is selected from the group consisting of:
receiving a measurement of a response time from a viewer location to said at least two sources;
estimating a response time based on statistical performance parameters of said at least two sources; and
estimating a response time base on a response time from a domain name server.

71. The method according to claim 56 further comprising:
at said retargetter system, providing candidate cache sources to a viewer and instructions for said viewer to report performance data regarding said cache sources;
at said retargetter system, receiving performance data from a viewer of a selected cache source;
at said retargetter, using said performance data as a criteria for selecting a cache source.

72. The method according to claim 56 further comprising:
modifying contained resource locators indicating HTML files or other files that may contain resource locators to indicate said retargetter as the delivery source of said pages;
modifying resource locators indicating embedded content indicating content that cannot contain further resource locators to indicate said selected cache source as the delivery source of said embedded content and said retargetter as the publisher of said content.

73. The method according to claim 56 further comprising:
caching a page with modified resource locators indicating a selected cache source;
when receiving a second request for said page, said second request further indicating the same selected cache source, returning a cached page.

74. A method of content delivery over a network comprising:
receiving a viewer request to access content;
redirecting said viewer request to a retargetter;
receiving performance data from one or more distribution sources;
determining a distribution source from which distributed content will be served;
in real time, modifying one or more content locators referenced by said content to indicate said distribution source; and
serving said content to said viewer.

75. The method according to claim 74 further comprising:
at said retargetter, receiving acceleration policy indications from a publisher and implementing said acceleration policy indications.

76. The method according to claim 74 further comprising:
providing executable code allowing a viewer to measure performance from one or more distribution sources; and
receiving performance measurements from said viewer.

77. The method according to claim 74 wherein said content is formatted in a protocol with standard universal resource locators (URLs).

78. The method according to claim 74 further comprising including an executable portion in content delivered to a viewer, said executable portion capable of modifying a location identifier displayed at a viewer.

79. A method of content delivery over a network comprising:
at a publisher network location, receiving a viewer request to access content;
redirecting said viewer request to a retargetter;
determining a distribution source from which distributed content will be served;
at said retargetter, retrieving publisher pages containing resource locators;
at said retargetter, providing a viewer said publisher pages, with resource locators translated to indicate embedded content from a determined distribution source; and
at said retargetter, responding to requests from said determined distribution source for embedded content by retrieving said embedded content and transmitting it to said determined distribution source.

80. The method according to claim 9 or 12 further comprising:
for a request for a publisher's content, measuring performance from at least two sources, said at least two sources not necessarily managed by the same content distribution network.

81. The method according to claim 9 or 12 wherein said measuring performance comprises:
requesting a test file located at a publisher site from two or more different cache sources;
selecting a cache source that is first to return said test file.

82. The method according to claim 9 or 12 further comprising:
receiving payment requests from multiple selected content distribution network;
paying said multiple content distribution networks; and
providing a single bill to a publisher from content distribution services.

83. The method according to claim 9 or 12 further comprising:
receiving payment requests from multiple content distribution networks for providing distribution services to one or more retargetters;
paying said payment requests for distributing content from retargetters; and
billing publishers for content distribution services provided through or managed by said retargetters.

84. The method according to claim 12 further comprising:
using an accounting computer system to track and pay payment requests from multiple content distribution networks for providing distribution services to one or more retargetters;
using said computer system to track and bill publishers for content distribution services provided through or managed by said retargetters.

85. The method according to claim 21 further comprising:
for a particular publisher, using said accounting computer system to track acceleration services provided by different independent content distribution networks and differing charges of said different independent content distribution networks;
using said accounting computer system to provide an aggregate billing to a publisher based on differing charges of said different independent content distribution networks.

86. The method according to claim 21 further comprising:
for a particular publisher, using said accounting computer system to track acceleration services provided by retargetters to provide a bill to a publisher based on retargetter services provided and without regard for different charges of said different independent content distribution networks.

87. A method of providing content distribution services to a publisher, comprising:
establishing service agreements with at least two independent content distribution networks to provide network content distribution services to one or more retargetters;
for a viewer request for publisher content, using a computer to select a distribution source from said at least two independent content distribution networks;
using a computer to redirect said viewer request to a selected distribution source; and
delivering requested publisher content to said selected distribution source.

88. The method according to claim 88 further comprising:
at a retargetter computing system, receiving acceleration policies from a publisher; and
translating publisher acceleration policies using a computer system to a selected distribution source.

89. A fixed media containing logical instructions that when loaded into an appropriately configured digital apparatus causes the apparatus to operate in accordance with the method of claim 87.

90. A method of content delivery over a network comprising:
establishing a two-tiered content distribution system, comprising:
first tier computer communication modules for providing distributed content to viewers from two or more independent publishers said first tier able to dynamically translate resource locators;
second tier computer communication modules for providing embedded distributed content to said viewers, said embedded distributed content accessed by said viewers via resource locators dynamically translated by said first tier.

91. The method according to claim 90 further wherein said second tier receives embedded publisher content from said first tier systems and said first tier systems request embedded content from original publishers to provide to said second tier systems.

92. The method according to claim 90 further wherein said second tier comprises one or more independent content distribution networks, each said independent content distribution network providing services to said first tier modules as though said modules comprised a single publisher site.

93. The method according to claim 90 further wherein said second tier comprises one or more independent content distribution networks, which may operate according to different resource locator mapping techniques and wherein said first tier modules dynamically translate resource locators to a format appropriate to a particular selected content distibution network before transmitting to a viewer.

94. The method according to claim 90 further wherein a module in said first tier may at times translate resource locators so that said module can at times act as a proxy second tier module for some viewers.

95. The method according to claim 90 further wherein said viewers communicate with said first tier modules and said second tier modules over a public, open protocol communications media.

96. The method according to claim 90 further wherein said viewers comprise general purpose browser modules for accessing a variety of network content in a standard network protocol.

97. The method according to claim 90 further wherein said second tier modules comprise independent content distribution networks that provide services to a variety of publishers on a public communications network.

98. A method allowing digital content publishers to easily initiate content distribution services to viewers comprising:
at a publisher site, a publisher providing a single redirection of a high level content location to an intermediate system;
at said intermediate node:
providing a viewer with instructions to capture performance data for two or more content distribution networks;
selecting a content distribution network for embedded content;
fetching publisher content containing resource locators of embedded content;
dynamically translating resource locators of embedded content in said publisher content to indicate a selected content distribution network;
providing content with translated resource locators to said viewer;
responding to requests for content from a selected content distribution network by fetching content from a publisher site when necessary and serving said content to a content distribution network.

99. A method allowing digital content publishers to easily initiate content distribution services to viewers comprising:
at a publisher site, a publisher providing a single redirection of a high level content location to an intermediate node;
at said intermediate node:
coordinating selection of a content distribution network for embedded content;
communicating selecting of a selected distribution network with a viewer;
fetching necessary publisher content from a publisher website;
serving necessary publisher content to said viewer and said selected content distribution network;
providing any necessary redirection in said publisher content to direct said viewer to said selected content distribution network.

100. The method according to claim 98 or 99 further comprising:
once a publisher desires a more permanent acceleration arrangement for a publisher site, accepting a redirection via a publisher sub-domain allocation to an intermediate service.

101. The method according to claim 98 or 99 further comprising:
at said intermediate node, performing content distribution in accordance with one or more acceleration policies, wherein said acceleration policies can comprise one or more of:
default acceleration policies requiring no data from a publisher;
static acceleration policies received from a publisher;
interactively generated acceleration policies created using an acceleration policy application.

102. The method according to claim 98 or 99 further comprising:
providing a policy application to implement acceleration policies at a computing site not managed by a publisher;
providing an interface allowing a publisher, using a standard remote interface, to initiate or modify acceleration policies for the publisher's content; and
translating acceleration policies for a publisher's content to a selected content distribution network.

103. A system for allowing publishers to accelerate content delivery comprising:
a policy application and interface able to receive acceleration policies from a publisher and to implement said acceleration policies;
one or more retargetters able to receive redirected requests from a viewer and in response determine a distribution source for a particular request;
logic processing able to modify locators in a content file to indicate said distribution source; an interface capable to provide content to one or more distribution sources as needed.

104. A system according to claim 103 further comprising:
at least one retargetter with efficient connections to a publisher and major internet backbones and able to deliver publisher data to a viewer in a minimum number of backbone steps.

105. A method to for redirecting viewer content requests comprising:
receiving, from a viewer system, performance measures for one or more cache content providers;
selecting one or more cache providers for serving said viewer content requests;
receiving a viewer request to access content;
redirecting said viewer request to a retargetter;
receiving performance measures from one or more distribution sources;
determining a distribution source from which additional content will be served;
in real time, modifying one or more content locators referenced by said content to indicate said distribution source; and
serving said content to said viewer.

106. The method according to claim 105 further comprising:
wherein said receiving said performance measures from one or more distribution sources includes receiving a performance measure from at least one retargetter acting as a forwarding switch from said publisher; and
determining said at least one retargetter as a distribution source when indicated by said performance measures.

107. A method for providing content distribution for a plurality of publishers comprising:
receiving content and acceleration policies from said plurality of publishers;
receiving viewer browser requests from a plurality of viewers;
providing publisher content to a plurality of distribution sources in two or more content distribution networks; and
dynamically redirecting viewer browser requests to a plurality of distribution sources in two or more content distribution networks.

108. The method according to claim 107 further comprising:
receiving publisher acceleration policies from a plurality of publishers; and
forwarding said acceleration policies to two or more content distribution networks or other communication networks.

109. A method to accelerate delivery of data over a network comprising:
providing executable code allowing a viewer to measure performance from one or more distribution sources;
receiving a viewer request to access content;
receiving performance measurements for one or more distribution sources from said viewer viewer;
determining a distribution source from which additional content will be served;
in real time, modifying one or more locators referenced by said content to indicate said distribution source; and
serving said content to said viewer.

110. The method according to claim 109 further comprising:
providing a viewer with identifications of one or more distribution sources.

111. The method according to claim 109 wherein said locator is a universal resource locator.

112. The method according to claim 109 wherein said locator is a DNS entry.

113. The method according to claim 109 wherein said locator is selected from the group consisting of:
a universal resource locator, and
a DNS entry.

114. A method making redirection less noticeable by a viewer comprising:
including an executable portion in redirected content, said executable portion capable of modifying a location identifier displayed to a viewer.

115. A method allowing publishers to manage accelerated content delivery comprising:
providing a policy application to implement acceleration policies at a computing site not managed by a publisher;
providing an interface allowing a publisher, using a standard remote interface, to initiate or modify acceleration policies for the publisher's content; and
implementing acceleration policies for a publisher's content.
